(19) United States
(12) Patent Application Publication
(10) Pub. No.: US 2018/0242016 A1
(43) Pub. Date: Aug. 23, 2018

(54) DEBLOCK FILTERING FOR 360 VIDEO

(71) Applicant: Intel Corporation, Santa Clara, CA (US)

(72) Inventors: Sang-Hee LEE, Santa Clara, CA (US); Ximin ZHANG, San Jose, CA (US); Jill M. BOYCE, Portland, OR (US); Yi-Jen CHIU, San Jose, CA (US); Keith W. ROWE, Shingle Springs, CA (US)

(21) Appl. No.: 15/438,128

(22) Filed: Feb. 21, 2017

(51) Int. Cl. H04N 19/597; H04N 19/182; H04N 19/124; H04N 19/48; H04N 19/184

(52) U.S. Cl. CPC H04N 19/597; H04N 19/182; H04N 19/184; H04N 19/48; H04N 19/124

(57) ABSTRACT

Techniques related to deblock filtering for 360 video are discussed. Such video coding techniques include determining, from a 2D video frame that includes a projection from a 360 video space, a group of pixels for deblock filtering including a first set of pixels and a second set of pixels that are non-neighboring sets of pixels in the individual 2D video frame and include a first pixel of the first set of pixels and a second pixel of the second set of pixels that are neighboring pixels in the 360 video space and deblock filtering the group of pixels.

### BACKGROUND

In 360 video, which is also known as 360 degree video, immersive video, or spherical video, video recordings are taken from every direction (i.e., over 360 degrees) simultaneously using an omnidirectional camera or a collection of cameras or the like. In playback, the viewer may select a viewing direction or viewport for viewing among any of the available directions. In compression/decompression (codec) systems, compression efficiency, video quality, and computational efficiency are important performance criteria. Furthermore, the compression/decompression of 360 video will be an important factor in the dissemination of 360 video and the user experience in the viewing of such 360 video.

Therefore, it may be advantageous to increase the compression efficiency, video quality, and computational efficiency of codec systems for processing 360 video. It is with respect to these and other considerations that the present improvements have been needed.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example system for deblocking 2D video frames that are projected from a 360 video space;

FIG. 2 illustrates an example 2D video frame including a projection from a 360 video space in an equirectangular format and viewport overlaying the 2D video frame;

FIG. 3 illustrates example deblock filtering within viewport;

FIG. 4 illustrates an example 2D video frame including a projection from a 360 video space in an equirectangular format and selected groups of pixels for deblock filtering

FIGS. 5 and 6 illustrate an example 2D video frame including a projection from a 360 video space in a cube map format and selected groups of pixels for deblock filtering;

FIG. 7 illustrates an example cube for receiving projections from a 3D video space;

FIGS. 8 and 9 illustrate an example 2D video frame including a projection from a 360 video space in a compact cube map format and selected groups of pixels for deblock filtering;

FIG. 10 illustrates a block diagram of an example encoder;

FIG. 11 illustrates a block diagram of an example decoder;

FIG. 12 illustrates a block diagram of an example encoder;

FIG. 13 illustrates a block diagram of an example decoder;

FIG. 14 is a flow diagram illustrating an example process for video coding video frames that include projections from a 360 video space;

FIG. 15 is an illustrative diagram of an example system for video coding video frames that include projections from a 360 video space;

FIG. 16 is an illustrative diagram of an example system; and

FIG. 17 illustrates an example device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

Methods, devices, apparatuses, computing platforms, and articles are described herein related to video coding and, in particular, to deblock filtering 2-dimensional (2D) video frames that are projections from a 360 video space.

The techniques discussed herein provide deblocking for 360 video. For example, deblocking may be enabled along boundaries of 2D video frames and faces of such 2D video frames that are discontiguous in the projected 2D plane when such boundaries are contiguous in the corresponding 360 video (e.g., in the corresponding 360 video sphere). In particular, in some 360 video coding contexts, 2D video frames that are projections from a 360 video space (e.g., projections from 360 video to a 2D plane based on a predetermined format) may be provided to an encoder for encoding into a bitstream such as a standards compliant bitstream. The bitstream may be stored or transmitted or the like and processed by a decoder. The decoder such as a standards compliant decoder may decode the bitstream to reconstruct the 2D video frames (e.g., the projections from the 360 video). The reconstructed 2D video frames may be processed for presentation to a user. For example, a selected viewport may be used to determine a portion or portions of the reconstructed 2D video frames, which may be assembled as needed and provided to a display device for presentation to a user.

In such techniques, the standards compliant codec (encode/decode) techniques may include in-frame deblock filtering for adjacent or neighboring pixels in video frames that cross block (e.g., macroblock, coding unit, etc.) boundaries. However, in projecting from the 360 video space to 2D video frames, some pixels that are neighbors in the 360 video space are presented or formatted as non-neighboring pixels in the 2D video frames. As used herein the term non-neighboring is meant to indicate pixels are not spatially adjacent (e.g., in a 2D video frame) and that sets of pixels have no neighboring pixels between them (e.g., that no pixel of a first set of pixels spatially neighbors any pixel of a second set of pixels in a 2D video frame). For example, such neighboring pixels in the 3D video space may be on opposite boundaries of the corresponding 2D video frame, on non-adjacent boundaries of face projections within the corresponding 2D video frame, or the like, as is discussed further herein.

In some embodiments, a group of pixels for deblock filtering may be identified within a 2D video frame that is a projection from a 360 video space such that the group of pixels includes a first set of pixels and a second set of pixels that are non-neighboring sets of pixels in the 2D video frame and such that they have a first individual pixel of the first set of pixels and a second individual pixel of the second set of pixels that are neighboring pixels in the 360 video space. The identified group of pixels (e.g., a line of pixels with the first and second sets of pixels on opposite sides of a boundary) are deblock filtered using a low pass filter or the like to determine filtered pixel values. Such techniques may be repeated on a line by line basis for any or all sets of pixels that are non-neighboring in the 2D video frame but neighboring pixels in the 360 video space to generate a 360 video space deblock filtered 2D video frame based on the individual 2D video frame.

Such pixel selection or matching and deblock filtering techniques may be implemented in any suitable encode, decode, video preprocessing, or video post-processing context. For example, such techniques may be applied within a local encode loop of a video encoder, as pre-processing prior to providing video frames to an encoder, as post decoder processing, or the like, as is discussed further herein. Furthermore, the discussed techniques may be used in any suitable coding context such as in the implementation of H.264/MPEG-4 advanced video coding (AVC) standards based codecs, high efficiency video coding (H.265/HEVC) standards based codecs, proposed video coding (H.266) codecs, Alliance for Open Media (AOM) standards based codecs such as the AV1 standard, MPEG standards based codecs such as the MPEG-4 standard, VP9 standards based codecs, or any other suitable codec or extension or profile thereof. The discussed techniques reduce blocky artifacts of coded video displayed to users and provide an improved 360 video experience.

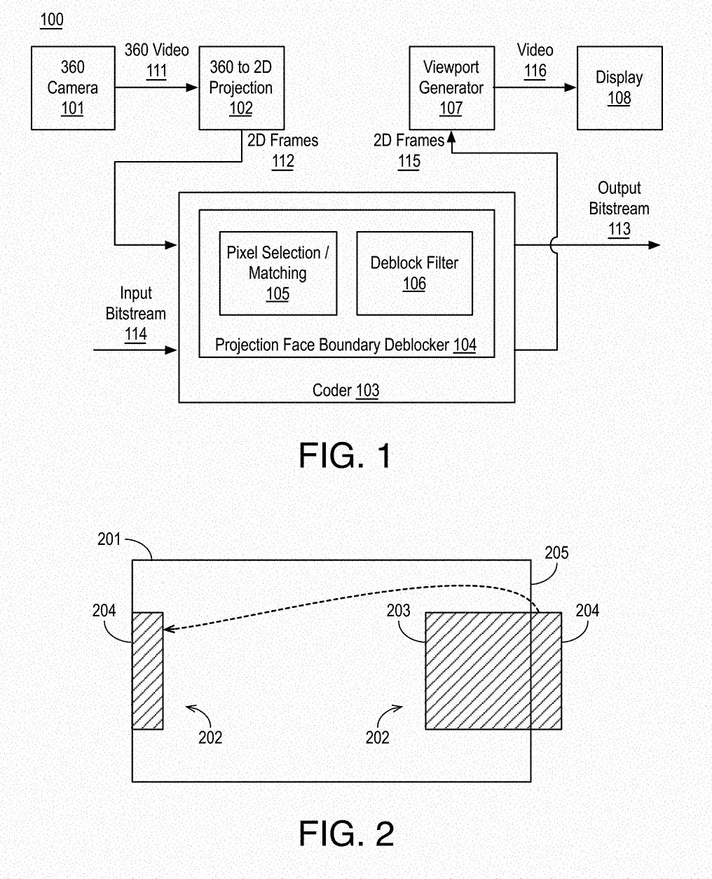

FIG. 1 is an illustrative diagram of an example system 100 for deblocking 2D video frames that are projected from a 360 video space, arranged in accordance with at least some implementations of the present disclosure. As shown in FIG. 1, system 100 may include a 360 camera 101, a 360 to 2D projection module 102, a coder 103, a viewport generator 107, and a display 108. Also as shown, coder 103 may implement a projection face boundary deblocker 104, which may include a pixel selection and matching module 105 and a deblock filter 106.

As shown, in some contexts, coder 103 may receive 2D video frames 112 (e.g., 2D video frames that are projected from a 360 or spherical space) from 360 to 2D projection module 102 and coder 103 may generate a corresponding output bitstream 113. Although illustrated with respect to coder 103 receiving 2D video frames 112 from 360 to 2D projection module 102, coder 103 may receive 2D video frames 112 from any source such as memory, another device, or the like. In such contexts, coder 103 may provide an encoder capability for system 100 (and, in such contexts input bitstream 114 and 2D video frames 115 may not be employed). 360 camera 101 may be any suitable camera or group of cameras that may attain 360 video or spherical video or the like. Furthermore, 360 to 2D projection module 102 may receive 360 video 111 and 360 to 2D projection module 102 may generate 2D video frames 112 using any suitable technique or techniques. For example, 360 to 2D projection module 102 may project 360 video 111 to 2D video frames 112 in any suitable 2D format that represents the projection from 360 video.

Other modules or components of system 100 may also receive 2D video frames 112 or portions thereof as needed. System 100 may provide, for example, video compression and system 100 may be a video encoder implemented via a computer or computing device or the like. For example, system 100 may generate output bitstream 113 that is compatible with a video compression-decompression (codec) standard such as the H.264/MPEG-4 advanced video coding (AVC) standard, the high efficiency video coding (H.265/HEVC) standard, proposed video coding (H.266) standards, the VP8 standard, the VP9 standard, or the like.

In other embodiments, coder 103 may receive an input bitstream 114 corresponding to or representing 2D frames that are projected from a 360 or spherical space and coder 103 may generate corresponding 2D video frames 115 (e.g., such that 2D frames are projected from a 360 or spherical space). Input bitstream 114 may be received from memory, another device, or the like. In such contexts, coder 103 may provide a decoder capability for system 100 (and, in such contexts 2D video frames 112 and output bitstream 113 may not be employed). In an embodiment, input bitstream may be decoded to 2D video frames 115, which may be displayed to a user via display 108 based on a selected viewport within 2D video frames. Display 108 may be any suitable display such as a virtual reality (VR) display, a head mounted VR display, or the like.

Furthermore, although illustrated with all of 360 camera 101, 360 to 2D projection module 102, coder 103, viewport generator 107, and display 108, system 100 may include only some of 360 camera 101, 360 to 2D projection module 102, coder 103, viewport generator 107, and display 108. In an embodiment, system 100 includes 360 camera 101, and 360 to 2D projection module 102, and coder. In an embodiment, system 100 includes coder 103, viewport generator 107, and display 108. Other combinations of 360 camera 101, 360 to 2D projection module 102, coder 103, viewport generator 107, and display 108 as well as other components may be provided for system 100 depending on the nature of the device in which system 100 is being implemented. System 100 may be implemented via any suitable device such as, for example, a server, a personal computer, a laptop computer, a tablet, a phablet, a smart phone, a digital camera, a gaming console, a wearable device, a display device, an all-in-one device, a two-in-one device, or the like or platform such as a mobile platform or the like. For example, as used herein, a system, device, computer, or computing device may include any such device or platform.

As discussed, coder 103 may receive 2D video frames 112. 2D video frames 112 (as well as 2D video frames 115 and other video frames discussed herein) may include any suitable video data such as pixels or pixel values or data, video sequence, pictures of a video sequence, video frames, video pictures, sequence of video frames, group of pictures, groups of pictures, video data, or the like in any suitable resolution. 2D video frames 112 may be characterized as video, input video data, video data, raw video, or the like. For example, 2D video frames 112 may be video graphics array (VGA), high definition (HD), Full-HD (e.g., 1080p), or 4K resolution video, or the like. Furthermore, 2D video frames 112 may include any number of video frames, sequences of video frames, pictures, groups of pictures, or the like. Techniques discussed herein are discussed with respect to pixels and pixel values of video frames for the sake of clarity of presentation. However, such video frames and/or video data may be characterized as pictures, video pictures, frames, sequences of frames, video sequences, or the like. As used herein, the term pixel or pixel value may include a value representing a pixel of a video frame such as a luminance value for the pixel, a color channel value for the pixel, or the like. In various examples, 2D video frames 112 may be raw video or decoded video. Furthermore, as discussed herein, coder 103 may provide both encode and decode functionality.

As shown, projection face boundary deblocker 104 receives 2D video frames 112 that include projections from a 360 video space. As used herein, the term projected from a 360 video space indicates the format of 2D video frames includes picture or video information corresponding to a 360 space, spherical space, or the like. For example, 360 video may be formatted or projected to a 2D image or video frame plane or the like using known techniques. Analogies to such projections (and their various advantages and disadvantages) may be found in the context of generating 2D maps from the globe. The format of such 2D video frames may include any suitable format such, for example, an equirectangular (ERF) format, a cube map format, a compact cube map format, or the like.

Pixel selection and matching module 105 may determine, for some or all of 2D video frames 112 groups of pixels for deblock filtering. Pixel selection and matching module 105 may determine such groups of pixels for deblock filtering using any suitable technique or techniques. In an embodiment, pixel selection and matching module 105 may receive an indicator or indicators indicative of a format type of 2D video frames 112 (e.g., equirectangular format, cube map format, compact cube map format, or the like) and pixel selection and matching module 105 may determine groups of pixels for deblock filtering responsive to the format type indicator or indicators. Each of such group of pixels for deblock filtering include a first set of pixels and a second set of pixels such that the first and second set of pixels are non-neighboring in the 2D video frame but such that the are neighboring in the 360 video space. Furthermore, such first and second sets of pixels are separated by a boundary across which deblock filtering may be applied. The boundary may be provided by a frame boundary of the 2D video frame, a face boundary of a projection portion of the 2D video frame, or the like. For example, the two sets of pixels of a group of pixels may be selected and oriented/aligned for deblock filtering. As shown in FIG. 1, such deblock filtering may be applied by deblock filter 106 of projection face boundary deblocker 104. The deblocked pixels may be used by coder 103 as a part of encode, decode, pre-, or post-processing as is discussed further herein.

FIG. 2 illustrates an example 2D video frame 201 including a projection from a 360 video space in an equirectangular format and viewport 202 overlaying 2D video frame 201, arranged in accordance with at least some implementations of the present disclosure. In the example of FIG. 2, 2D video frame 201 includes a projection of 360 video in the equirectangular format, which is also discussed herein with respect to FIG. 4. For example, the equirectangular format may project a spherical 3D image or frame onto orthogonal coordinates of a 2D image or frame. As shown in FIG. 2, a viewport 202 may be applied with respect to 2D video frame 201 (e.g., by viewport generator 107, please refer to FIG. 1) such that a user may desire to view video corresponding to viewport 202. Also as shown, viewport 202 may wrap around 2D video frame 201 such that a portion 203 of viewport 202 is on a right side of 2D video frame 201 and another portion 204 of viewport 202 is on a left side of 2D video frame 201. For example, to attain the video data of viewport 202 for presentation, portion 204 of viewport 202, which overextends frame boundary 205 of 2D video frame 201, must be attained from the left side of 2D video frame 201. An assembled viewport 202 including portions 203, 204 may be presented to a user for example.

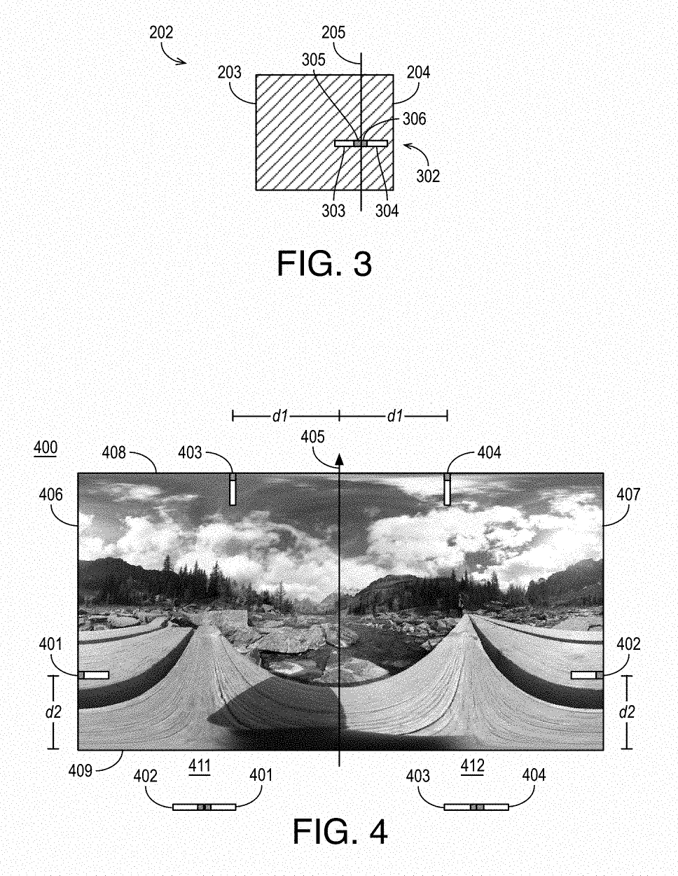

FIG. 3 illustrates example deblock filtering within viewport 202, arranged in accordance with at least some implementations of the present disclosure. As shown in FIG. 3, a group of pixels 302 may be selected for deblock filtering such that group of pixels 302 includes a set of pixels 303 and a set of pixels 304 that are neighboring in the 360 video space but not in the corresponding 2D video frame projection. For example, viewport 202 provides a contiguous view in the 360 video space. Furthermore, set of pixels 303 and set of pixels 304 are discontiguous non-neighboring pixels in 2D video frame 201 since set of pixels 303 is from a right side of 2D video frame 201 and set of pixels 304 is from a left side of 2D video frame 201 (please refer to FIG. 2). For example, set of pixels 303 and set of pixels 304 are separated by boundary 205 such that boundary 205 separates pixels that are non-neighboring in the 2D video frame space but neighboring in the 360 or spherical space. Therefore, set of pixels 303 and set of pixels 304 may be advantageously deblock filtered for an improved appearance of viewport 202 (or for improved video coding efficiency in other contexts).

Also as shown, set of pixels 303 includes a pixel 305 (marked with a gray box) along boundary 205 and set of pixels 304 includes a pixel 306 (also marked with a gray box) that are neighbors in the 3D video space but not in the 2D video frame. In deblock filtering of group of pixels 302, set of pixels 303 and set of pixels 304 may be aligned (e.g., put in a row or column) such that 3D video space neighboring pixels 305, 306 are set next to one another for deblock filtering. In the following illustrations such 3D video space neighboring pixels are marked with gray boxes for the sake of clarity of presentation.

As discussed with respect to system 100, group of pixels 302 may be selected by pixel selection and matching module 105, aligned for deblock filtering by pixel selection and matching module 105, and deblock filtered by deblock filter 106 to generate deblock filtered pixels or pixel values or the like. Any groups of pixels selection and/or deblock filtering discussed herein may be performed by pixel selection and matching module 105 and deblock filtered by deblock filter 106, respectively. Furthermore, any deblock filtering discussed herein may be performed for a group of pixels across a boundary (e.g., for group of pixels 302 across boundary 205 or the like) using any suitable technique or techniques. For example, group of pixels 302 may include N pixels such that N/2 are from set of pixels 303 and N/2 are from set of pixels 304. In various embodiments, N may be in the range of about 4 to 16 or the like. In other examples, set of pixels 303 and set of pixels 304 may have different numbers of pixels. The deblock filtering may include any filtering such as low pass filtering, weighted filtering with any suitable weights, or the like. In an embodiment, the deblock filtering may be provided in accordance with HEVC deblock filtering for neighboring pixels across block boundaries. In an embodiment, group of pixels 302 includes a single line of pixels that may be deblock filtered.

The same deblock filter may be applied to each selected group of pixels or the deblock filters (e.g., their length, weightings, or the like) may be different. In some embodiment, the selected deblock filter may be based on block sizes, prediction types, transform types, or the like corresponding to the blocks from which the sets of pixels are selected. In an embodiment, when a group of pixels has a set of pixels or both sets of pixels are from a smaller block or blocks (e.g., a block of 8×8 or less), a shorter filter is used (e.g., about 4 pixels) and when group of pixels has a set of pixels or both sets of pixels are from a larger block or blocks (e.g., a block larger than 8×8), a longer filter is used (e.g., about 8 or more pixels). In an embodiment, when a group of pixels has a set of pixels or both sets of pixels are from an intra predicted block or blocks, a shorter filter is used (e.g., about 4 pixels) and when group of pixels has a set of pixels or both sets of pixels are from an inter predicted block or blocks, a longer filter is used (e.g., about 8 or more pixels).

With reference to FIG. 2, additional groups of pixels (e.g., lines of pixels) may be selected across boundary 205 such that first and second sets of pixels are from a right side of 2D video frame 201 (e.g., adjacent to a right boundary or edge of 2D video frame 201) and a left side of video frame 201 (e.g., adjacent to a left boundary or edge of 2D video frame 201), respectively. For example, in the equirectangular format, all leftmost and corresponding rightmost pixels of 2D video frame 201 are neighboring in the 360 video space while being non-neighboring (non-contiguous) in 2D video frame 201. Such deblock filtering of pixel groups along may be performed for some or all lines of pixels that include pixels from the left and right sides of 2D video frame 201 (e.g., all horizontal lines of pixels that boundary 205 and the left boundary of 2D video frame 201).

FIG. 4 illustrates an example 2D video frame 400 including a projection from a 360 video space in an equirectangular format and selected groups of pixels for deblock filtering, arranged in accordance with at least some implementations of the present disclosure. In the example of FIG. 4, 2D video frame 400, as in FIG. 2, includes a projection of 360 video in the equirectangular format. As shown in FIG. 4, groups of pixels including groups of pixels 411, 412 may be selected for deblock filtering. For example, group of pixels 411 includes set of pixels 401 and set of pixels 402, in analogy with group of pixels 302 as illustrated in FIG. 3. For example, for deblock filtering, set of pixels 401 may be aligned to the right of set of pixels 402 and deblock filtering may be performed. Furthermore, group of pixels 412 includes set of pixels 403 and set of pixels 404 such that, for deblock filtering, set of pixels 403 may be inverted and aligned to the top of set of pixels 404 (or vice versa) and deblock filtering may be performed.

As shown, set of pixels 401 and set of pixels 402 are non-neighboring in 2D video frame 400 (i.e., no pixel of set of pixels 401 is contiguous with or adjacent to any pixel of set of pixels 402 in 2D video frame 400). However, in the 360 video space, a pixel of set of pixels 401 at frame boundary 406 (marked with a gray box within set of pixels 401) is a neighbor of a pixel of set of pixels 402 at frame boundary 407 (marked with a gray box within set of pixels 402). For example, set of pixels 401 may begin at the marked pixel of set of pixels 401 at frame boundary 406 and extend toward an interior of 2D video frame 400 and set of pixels 402 may begin at the marked pixel of set of pixels 402 at frame boundary 407 and extend toward an interior of 2D video frame 400. Furthermore, first and second sets of pixels 401, 402 may be the same distance (d2) from a bottom frame boundary 409 (and a top frame boundary 408). With reference to FIG. 4, in the equirectangular format, for any horizontal set of pixels adjacent to left frame boundary 406, a corresponding horizontal set of pixels adjacent to right frame boundary 407 (at the same distance from bottom frame boundary 409 or top frame boundary 409) may be found such that the sets of pixels are non-neighboring in 2D video frame 400 but neighboring in the 360 video space to generate a group of pixels in analogy with group of pixels 411.

Furthermore, FIG. 4 illustrates group of pixels 411 including set of pixels 403 and set of pixels 404 for deblock filtering. For example, for deblock filtering, set of pixels 403 may be inverted and aligned to the top of set of pixels 404 (or set of pixels 404 may be inverted and aligned to the top of set of pixels 403) and deblock filtering may be performed. As shown, set of pixels 403 and set of pixels 404 are non-neighboring in 2D video frame 400 (i.e., no pixel of set of pixels 403 is contiguous with or adjacent to any pixel of set of pixels 404). However, in the 360 video space, a pixel of set of pixels 403 at frame boundary 408 (marked with a gray box within set of pixels 403) is a neighbor of a pixel of set of pixels 404 also at frame boundary 408 (marked with a gray box within set of pixels 404) and equidistant (i.e., both at d1) from centerline 405 of 2D video frame 400. For example, set of pixels 403 may begin at the marked pixel of set of pixels 403 at frame boundary 408 and extend toward an interior of 2D video frame 400 and set of pixels 404 may begin at the marked pixel of set of pixels 404 at frame boundary 408 and extend toward an interior of 2D video frame 400. Furthermore, as discussed, first and second sets of pixels 403, 404 may be the same distance (d1) from a north pole of 2D video frame 400 (i.e., centerline 405 of 2D video frame 400).

With reference to FIG. 4, for any vertical set of pixels adjacent to top frame boundary 408 (except for pixels exactly at centerline 405, if any), a corresponding vertical set of pixels also adjacent to top frame boundary 408 may be found such that the sets of pixels are non-neighboring in 2D video frame 400 but neighboring in the 360 video space. For example, for a vertical set of pixels adjacent to top frame boundary 408 and left of centerline 405 by a distance, x, from centerline 405, the corresponding vertical set of pixels for deblock filtering may be found also adjacent to top frame boundary 408 and right of centerline 405 by the distance, x.

Similarly, for any vertical set of pixels adjacent to bottom frame boundary 409 (except for pixels exactly at centerline 405, if any), a corresponding vertical set of pixels also adjacent to bottom frame boundary 409 may be found such that the sets of pixels are non-neighboring in 2D video frame 400 but neighboring in the 360 video space. For example, for a vertical set of pixels adjacent to bottom frame boundary 409 and left of centerline 405 by a distance, x, from centerline 405, the corresponding vertical set of pixels for deblock filtering may be found also adjacent to bottom frame boundary 409 and right of centerline 405 by the distance, x. For such vertical sets of pixels adjacent to bottom frame boundary 409, the pixels of each set adjacent to bottom frame boundary 409 are neighboring in the 360 video space and such pixels may be placed adjacent to one another for deblock filtering in analogy to the x marked pixels of sets of pixels 403, 404.

As discussed, horizontal and vertical groups of any number of pixels may be determined and deblock filtered in 2D video frame 400. In an embodiment, all such available horizontal (i.e., all linear single pixel depth horizontal groups having a horizontal pixel set adjacent to left frame boundary 406 and a horizontal pixel set adjacent to right frame boundary 407) and vertical (i.e., all linear single pixel depth vertical groups having a vertical pixel set adjacent to top frame boundary 408 and a vertical pixel set adjacent to top frame boundary 408 and equidistant to the corresponding vertical pixel set and all linear single pixel depth vertical groups having a vertical pixel set adjacent to bottom frame boundary 409 and a vertical pixel set adjacent to bottom frame boundary 409 and equidistant to the corresponding vertical pixel set) groups of pixels are deblock filtered. In another embodiment, a subset of each of such available horizontal and vertical groups of pixels are deblock filtered. In any event, such deblock filtering may generate, from a 2D video frame, a 360 video space deblock filtered 2D video frame based on the 2D video frame. As used herein the term 360 video space deblock filtered 2D video frame is meant to indicate a 2D video frame that has been deblock filtered for neighbors in the 360 video space. Such a 360 video space deblock filtered 2D video frame may also be deblock filtered within the 2D video frame or not.

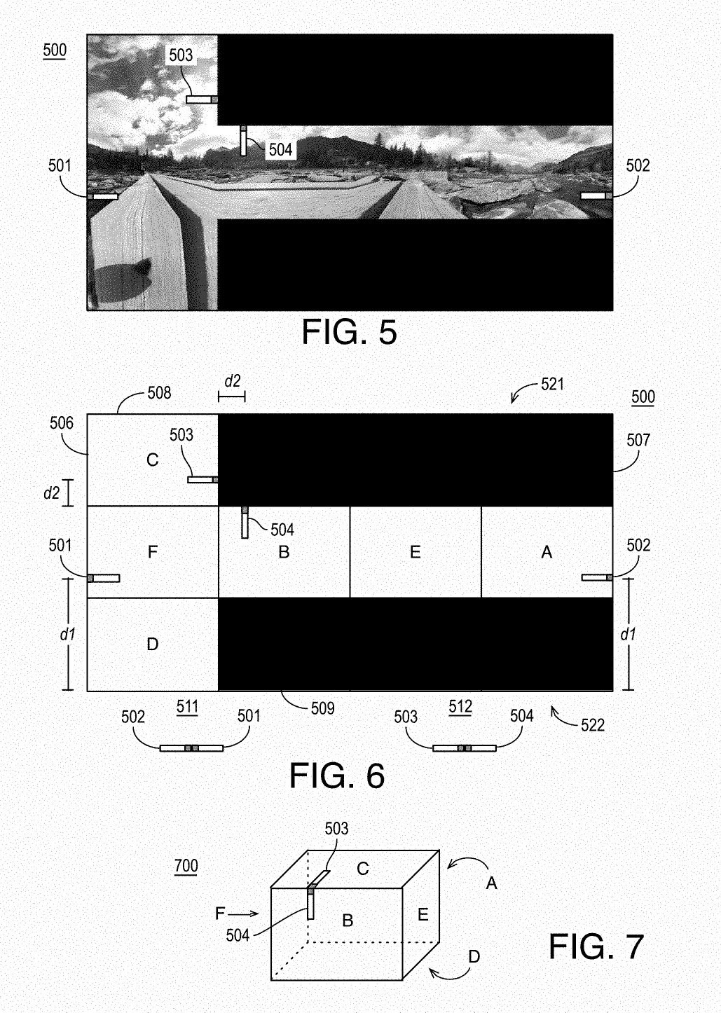

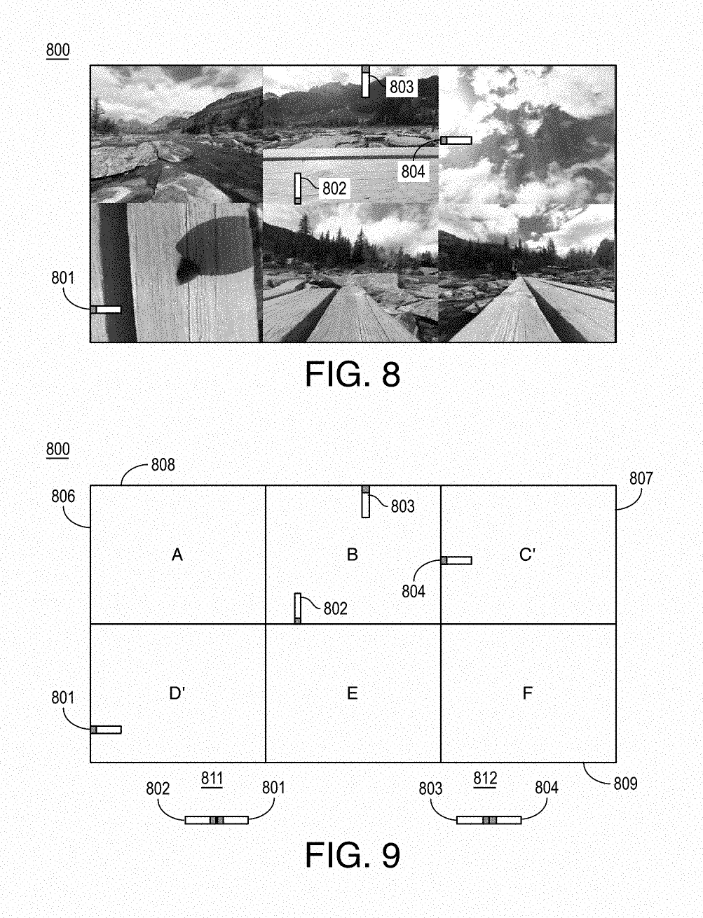

The described pixel selection and deblock filtering techniques for 2D video frame that are projections from a 360 video space may be performed for any format of projection. For example, the 2D video frame may be an equirectangular frame projected from the 360 video space (as discussed with respect to FIGS. 2-4 and elsewhere herein), a cube map format frame projected from the 360 video space (as discussed with respect to FIGS. 5 and 6 and elsewhere herein), a compact cube map format frame projected from the 360 video space (as discussed with respect to FIGS. 8 and 9 and elsewhere herein), an environment mapping to any shape, a geometric net of any 3D shape, or the like. For example, a cube map format may project the 360 video space onto the sides of a cube, which may be unfolded or arranged within the 2D video frame.

FIGS. 5 and 6 illustrate an example 2D video frame 500 including a projection from a 360 video space in a cube map format and selected groups of pixels for deblock filtering, arranged in accordance with at least some implementations of the present disclosure. As shown, FIG. 5 illustrates 2D video frame 500 with a 2D image and FIG. 6 illustrates 2D video frame 500 with the 2D image removed and portions of 2D video frame 500 labeled for the sake of clarity. As shown, groups of pixels including groups of pixels 511, 512 may be selected for deblock filtering. For example, group of pixels 511 includes set of pixels 501 and set of pixels 502 and, for deblock filtering, set of pixels 501 may be aligned to the right of set of pixels 502 and deblock filtering may be performed. Furthermore, group of pixels 512 includes set of pixels 503 and set of pixels 504 such that, for deblock filtering, set of pixels 503 may be rotated and aligned to the top of set of pixels 504 (or vice versa) and deblock filtering may be performed. As will be discussed further below, other combinations of pixel sets may be aligned into groups of pixels an deblock filtered.

FIG. 7 illustrates an example cube 700 for receiving projections from a 3D video space, arranged in accordance with at least some implementations of the present disclosure. As shown in FIG. 7, cube 700 has 6 faces (labeled A-F such that A is the back, B is the front, C is the top, D is the bottom, E is the right side, and F is the right side). For example, 3D video (e.g., frames or pictures) may be projected onto cube 700 such that each face of cube 700 includes a portion of the 3D video or sphere. With reference to FIG. 6, each face of cube 700, in the cube map format, may be laid open in an edge-join fashion across 2D video frame 500. For example, 2D video frame 500 includes a geometric net of cube 700. Although shown with the faces in a sideways T format, any suitable format may be used such as a compact cube format as discussed further below with respect to FIGS. 8 and 9.

As shown in FIG. 7, set of pixels 503 and set of pixels 504 may join at the boundary between faces B and C with respect to cube 700. For example, a pixel of set of pixels 503 at the boundary and a pixel of set of pixels 504 also at the boundary are neighboring pixels in the 3D video space projected onto cube 700. As is discussed further below, group of pixels 512 including set of pixels 503 and set of pixels 504 may be deblock filtered. Similarly, any group of pixels having a first set pixels extending orthogonally away from a boundary between adjacent faces along a face and a second set of pixels extending orthogonally away from the boundary along the other face shared by the boundary may be deblock filtered. For example, such groups of pixels may be formed between any orthogonal sets of pixels from face C and face B that have a shared pixel at the boundary between face C and face B (as shown with respect to set of pixels 503 and set of pixels 504), between any orthogonal sets of pixels from face C and face E that have a shared pixel at the boundary between face C and face E, between any orthogonal sets of pixels from face A and face F that have a shared pixel at the boundary between face A and face F (as shown with respect to set of pixels 501 and set of pixels 502 in FIGS. 5 and 6), and so on. It is noted that the discussed pixel selection and deblock filtering techniques may not be needed between faces F and B, between faces B and E, and between faces E and A, in the context of 2D video frame 500 because such filtering may be already applied during standard in-frame deblock filtering.

As shown with respect to FIG. 6, 2D video frame 500 includes a left frame boundary 506, a right frame boundary 507, a top frame boundary 508, and a bottom frame boundary 509. Furthermore, 2D video frame 500 may include blank pixel regions 521, 522, which are illustrated as black in 2D video frame 500 but may include any suitable color or pixel values. Also, as shown with respect to faces A-F, each face may have a left face boundary, right, face boundary, top face boundary, and bottom face boundary. Such boundaries may be shared with another face, a blank pixel region, or a frame boundary as shown. As discussed with respect to FIG. 7, sets of pixels (e.g., lines of pixels) at right angles to the following face boundaries may be matched, aligned, and deblock filtered: top boundary of face B with right boundary of face C, bottom boundary of face B with right boundary of face D, top boundary of face E with top boundary of face C, bottom boundary of face E with bottom boundary of face D, top boundary of face A with left boundary of face C, right boundary of face A with left boundary of face F, bottom boundary of face A with left boundary of face D.

As shown, set of pixels 501 and set of pixels 502 are non-neighboring in 2D video frame 500 (i.e., no pixel of set of pixels 501 is contiguous with or adjacent to any pixel of set of pixels 502 in 2D video frame 500). However, in the 360 video space, a pixel of set of pixels 501 at frame boundary 506 (at left boundary of face F, marked with a gray box within set of pixels 501) is a neighbor of a pixel of set of pixels 502 at frame boundary 507 (at right boundary of face A, marked with a gray box within set of pixels 502). For example, set of pixels 501 may begin at the marked pixel of set of pixels 501 at frame boundary 506 and extend toward an interior of 2D video frame 500 (and face F) and set of pixels 502 may begin at the marked pixel of set of pixels 502 at frame boundary 507 and extend toward an interior of 2D video frame 500 (and face A). Furthermore, first and second sets of pixels 501, 502 may be the same distance (d2) from a bottom frame boundary 509 (and a top frame boundary 508).

Furthermore, FIG. 5 illustrates group of pixels 512 including set of pixels 503 and set of pixels 504 for deblock filtering. For example, for deblock filtering, set of pixels 503 may be rotated and aligned to the top of set of pixels 504 (or set of pixels 504 may be rotated and aligned to the right of set of pixels 503) and deblock filtering may be performed. As shown, set of pixels 503 and set of pixels 504 are non-neighboring in 2D video frame 500 (i.e., no pixel of set of pixels 503 is contiguous with or adjacent to any pixel of set of pixels 504). However, in the 360 video space, a pixel of set of pixels 503 at the right boundary of face C (marked with a gray box within set of pixels 503) is a neighbor of a pixel of set of pixels 504 at the top boundary of face B (marked with a gray box within set of pixels 504) and equidistant (i.e., both at d2) from the corner of the right boundary of face C and the boundary of face B. For example, set of pixels 503 may begin at the marked pixel of set of pixels 503 at the right boundary of face C and extend toward an interior of face C and set of pixels 504 may begin at the marked pixel of set of pixels 504 at the top boundary of face B and extend toward an interior of face B.

With reference to FIGS. 5-7, for any vertical set of pixels beginning at the top boundary of face B, a corresponding horizontal set of pixels beginning at the right boundary of face C may be found and matched thereto for deblock filtering; for any vertical set of pixels beginning at the bottom boundary of face B, a corresponding horizontal set of pixels beginning at the right boundary of face D may be found and matched thereto for deblock filtering; for any vertical set of pixels beginning at the top boundary of face E, a corresponding vertical set of pixels beginning at the top boundary of face C may be found and matched thereto for deblock filtering; for any vertical set of pixels beginning at the bottom boundary of face E, a corresponding vertical set of pixels beginning at the bottom boundary of face D may be found and matched thereto for deblock filtering; for any vertical set of pixels beginning at the top boundary of face A, a corresponding horizontal set of pixels beginning at the left boundary of face C may be found and matched thereto for deblock filtering; for any horizontal set of pixels beginning at the right boundary of face A, a corresponding horizontal set of pixels beginning at the left boundary of face F may be found and matched thereto for deblock filtering; and for any vertical set of pixels beginning at the bottom boundary of face A, a corresponding horizontal set of pixels beginning at the left boundary of face D may be found and matched thereto for deblock filtering.

FIGS. 8 and 9 illustrate an example 2D video frame 800 including a projection from a 360 video space in a compact cube map format and selected groups of pixels for deblock filtering, arranged in accordance with at least some implementations of the present disclosure. As shown, FIG. 8 illustrates 2D video frame 800 with a 2D image and FIG. 9 illustrates 2D video frame 800 with the 2D image removed and portions of 2D video frame 800 labeled for the sake of clarity. As shown, groups of pixels including groups of pixels 811, 812 may be selected for deblock filtering. For example, group of pixels 811 includes set of pixels 801 and set of pixels 802 and, for deblock filtering, set of pixels 801 may be rotated and aligned to the bottom of set of pixels 802 (or vice versa) and deblock filtering may be performed. Furthermore, group of pixels 812 includes set of pixels 803 and set of pixels 804 such that, for deblock filtering, set of pixels 803 may be rotated and aligned to the right of set of pixels 804 (or vice versa) and deblock filtering may be performed. As will be discussed further below, other combinations of pixel sets may be aligned into groups of pixels an deblock filtered.

With reference to FIGS. 7 and 8, each face of cube 700, in the compact cube map format, may be provided within video frame 800 as shown. With respect to the alignment of the cube faces provided in FIG. 6, faces A, B, E, and F may have the same alignment while faces C′ and D′ may be rotated 180°. Although illustrated in a particular compact cube format, any suitable format may be used for the projection from the 360 video space.

As discussed above and with reference to FIG. 7, any group of pixels having a first set pixels extending orthogonally away from a boundary between adjacent faces along a face and a second set of pixels extending orthogonally away from the boundary along the other face shared by the boundary may be deblock filtered. For example, such groups of pixels may be formed between any orthogonal sets of pixels from face C and face B that have a shared pixel at the boundary between face C and face B, between any orthogonal sets of pixels from face C and face E that have a shared pixel at the boundary between face C and face E, between any orthogonal sets of pixels from face A and face F that have a shared pixel at the boundary between face A and face F, and so on. It is noted that the discussed pixel selection and deblock filtering techniques may be needed between all faces in the context of 2D video frame 800 because no adjacent faces in 2D video frame 800 are adjacent in the 3D video space.

As shown with respect to FIG. 9, 2D video frame 800 includes a left frame boundary 806, a right frame boundary 807, a top frame boundary 808, and a bottom frame boundary 809. Also, as shown with respect to faces A, B, C′, D′, E, F, each face may have a left face boundary, right, face boundary, top face boundary, and bottom face boundary. Such boundaries may be shared with another face or a frame boundary as shown. As discussed with respect to FIG. 7, sets of pixels (e.g., lines of pixels) at right angles to the following face boundaries may be matched, aligned, and deblock filtered: top boundary of face B with left boundary of face C′, bottom boundary of face B with left boundary of face D′, top boundary of face E with bottom boundary of face C′, bottom boundary of face E with top boundary of face D′, top boundary of face A with right boundary of face C′, right boundary of face A with left boundary of face F, bottom boundary of face A with right boundary of face D′.

As shown, set of pixels 801 and set of pixels 802 are non-neighboring in 2D video frame 800 (i.e., no pixel of set of pixels 801 is contiguous with or adjacent to any pixel of set of pixels 802 in 2D video frame 800). However, in the 360 video space, a pixel of set of pixels 801 at frame boundary 806 (at left boundary of face D′, marked with a gray box within set of pixels 801) is a neighbor of a pixel of set of pixels 802 at the bottom boundary of face B (marked with a gray box within set of pixels 802). For example, set of pixels 801 may begin at the marked pixel of set of pixels 801 at frame boundary 806 and extend toward an interior of 2D video frame 800 (and face D′) and set of pixels 802 may begin at the marked pixel of set of pixels 802 at the bottom boundary of face B and extend toward an interior of face B.

Furthermore, FIG. 8 illustrates group of pixels 812 including set of pixels 803 and set of pixels 804 for deblock filtering. For example, for deblock filtering, set of pixels 803 may be rotated and aligned to the left of set of pixels 804 (or set of pixels 804 may be rotated and aligned to the top of set of pixels 803) and deblock filtering may be performed. As shown, set of pixels 803 and set of pixels 804 are non-neighboring in 2D video frame 800 (i.e., no pixel of set of pixels 803 is contiguous with or adjacent to any pixel of set of pixels 804). However, in the 360 video space, a pixel of set of pixels 803 at the top boundary of face B (marked with a gray box within set of pixels 803) is a neighbor of a pixel of set of pixels 504 at the left boundary of face C′ (marked with a gray box within set of pixels 804). For example, set of pixels 803 may begin at the marked pixel of set of pixels 803 at the top boundary of face B and extend toward an interior of face B and set of pixels 804 may begin at the marked pixel of set of pixels 804 at the left boundary of face C′ and extend toward an interior of face C′.

With reference to FIGS. 7-9, for any vertical set of pixels beginning at the top boundary of face B, a corresponding horizontal set of pixels beginning at the left boundary of face C′ may be found and matched thereto for deblock filtering; for any vertical set of pixels beginning at the bottom boundary of face B, a corresponding horizontal set of pixels beginning at the left boundary of face D′ may be found and matched thereto for deblock filtering; for any vertical set of pixels beginning at the top boundary of face E, a corresponding vertical set of pixels beginning at the bottom boundary of face C′ may be found and matched thereto for deblock filtering; for any vertical set of pixels beginning at the bottom boundary of face E, a corresponding vertical set of pixels beginning at the top boundary of face D′ may be found and matched thereto for deblock filtering; for any vertical set of pixels beginning at the top boundary of face A, a corresponding horizontal set of pixels beginning at the right boundary of face C′ may be found and matched thereto for deblock filtering; for any horizontal set of pixels beginning at the right boundary of face A, a corresponding horizontal set of pixels beginning at the left boundary of face F may be found and matched thereto for deblock filtering; and for any vertical set of pixels beginning at the bottom boundary of face A, a corresponding horizontal set of pixels beginning at the right boundary of face D′ may be found and matched thereto for deblock filtering.

As discussed, the pixel selection and deblock filtering techniques discussed herein may be used in any suitable 3D video encode, decode, pre-, or post-processing context.

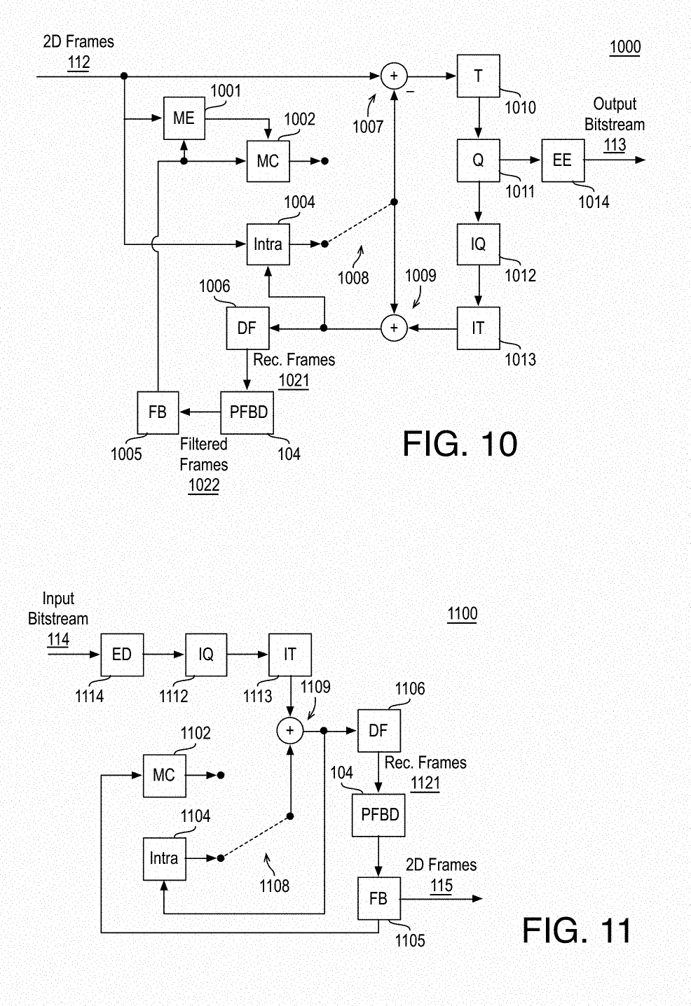

FIG. 10 illustrates a block diagram of an example encoder 1000, arranged in accordance with at least some implementations of the present disclosure. For example, encoder 1000 may provide in loop projection face boundary deblocking based on the techniques discussed herein. As shown, encoder 1000 may include a motion estimation (ME) module 1001, a motion compensation (MC) module 1002, an intra prediction (Intra) module 1004, a frame buffer (FB) 1005, an in-frame deblock filtering (DF) module 1006, a differencer 1007, a selection switch 1008, an adder 1009, a transform (T) module 1010, a quantization (Q) module 1011, an inverse quantization (IQ) module 1012, an inverse transform (IT) module 1013, an entropy encoder (EE) module 1014, and projection face boundary deblocker (PFBD) 104. Encoder 1000 may include additional modules and/or interconnections that are not shown for the sake of clarity of presentation.

As shown, encoder 1000 may receive 2D video frames 112 (e.g., 2D video frames that are projected from a 360 or spherical space) and encoder 1000 may generate output bitstream 113 as discussed herein. For example, encoder 1000 may divide an individual 2D frame of 2D video frames 112 into blocks of different sizes, which may be predicted either temporally (inter) via motion estimation module 1001 and motion compensation module 1002 or spatially (intra) via intra prediction module 1004. Such a coding decision may be implemented via selection switch 1008. Furthermore, based on the use of intra or inter coding, a difference between source pixels and predicted pixels may be made via differencer 1007 (e.g., between pixels of previously decoded 360 video space deblock filtered reconstructed frames and pixels of source or original frames). The difference may converted to the frequency domain (e.g., based on a discrete cosine transform) via transform module 1010 and converted to quantized coefficients via quantization module 1011. Such quantized coefficients along with various control signals may be entropy encoded via entropy encoder module 1014 to generate encoded bitstream 1021, which may be transmitted or transferred or the like to a decoder. Furthermore, as part of a local decode loop, the quantized coefficients may be inverse quantized via inverse quantization module 1012 and inverse transformed via inverse transform module 1013 to generate reconstructed differences or residuals. The reconstructed differences or residuals may be combined with reference blocks via adder 1009 to generate reconstructed blocks, which, as shown, may be provided to intra prediction module 1004 for use in intra prediction. Furthermore, the reconstructed blocks may be in-frame deblocked via deblock filtering module 1006 and reconstructed to generate reconstructed frames 1021. Reconstructed frames 1021 may be provided to projection face boundary deblocker 104 for deblocking of pixel groups that are non-neighbors in reconstructed frames 1021 and are neighbors in the 360 video space of which reconstructed frames 1021 include projections. As shown, projection face boundary deblocker 104 may generate 360 video space deblock filtered reconstructed frames (filtered frames) 1022 based on reconstructed frames 1021, which may be stored in frame buffer 1005 and provided to motion estimation module 1001 and motion compensation module 1002 for use in inter prediction.

By implementing encoder 1000 and, in particular, projection face boundary deblocker 104 within encoder 1000, improved encoding quality and compression and improved video quality of video represented by output bitstream 113 may be attained. For example, as discussed, projection face boundary deblocker 104 may receive an individual 2D reconstructed video frame of reconstructed video frames 1021 such that the individual 2D reconstructed video frame includes a projection from a 360 video space. Projection face boundary deblocker 104 determines groups of pixels from the individual 2D reconstructed video frame are non-neighboring in the individual 2D reconstructed video frame and that include pixels that are neighboring in the 360 video space. Such groups of pixels are deblock filtered to generate a filtered frame of 360 video space deblock filtered reconstructed frames 1022. Also as discussed, a portion (e.g., a block or coding unit or the like) of the 360 video space deblock filtered reconstructed frame may be differenced, by differencer 1007, with a corresponding portion of 2D video frames 112 (e.g., a portion of an original 2D video frame) to generate a residual portion. The residual portion may be transformed, by transform module 1010, and quantized, by quantization module 1011, to determine quantized transform coefficients for the residual portion. The quantized transform coefficients may be encoded into output bitstream 113 by entropy encoder module 1014.

FIG. 11 illustrates a block diagram of an example decoder 1100, arranged in accordance with at least some implementations of the present disclosure. For example, decoder 1100 may provide in loop projection face boundary deblocking based on the techniques discussed herein. As shown, decoder 1100 may include a motion compensation (MC) module 1102, an intra prediction (Intra) module 1104, a frame buffer (FB) 1105, an in-frame deblock filtering (DF) module 1106, a selection switch 1108, an adder 1109, an inverse quantization (IQ) module 1112, an inverse transform (IT) module 1113, an entropy decoder (ED) module 1114, and projection face boundary deblocker (PFBD) 104. Decoder 1100 may include additional modules and/or interconnections that are not shown for the sake of clarity of presentation.

As shown, decoder 1100 may receive input bitstream 114 (e.g., an input bitstream corresponding to or representing 2D video frames that are projected from a 360 or spherical space) and decoder 1100 may generate 2D video frames 115 (e.g., such that 2D frames are projected from a 360 or spherical space) as discussed herein. For example, entropy decoder module 1114 may entropy decode input bitstream 114 to determine quantized coefficients along with various control signals. The quantized coefficients may be inverse quantized via inverse quantization module 1112 and inverse transformed via inverse transform module 1113 to generate reconstructed differences or residuals. The reconstructed differences or residuals may be combined with reference blocks (from previously decoded frames) via adder 1109 to generate reconstructed blocks, which, as shown, may be provided to intra prediction module 1104 for use in intra prediction. Furthermore, the reconstructed blocks may be in-frame deblocked via deblock filtering module 1006 and reconstructed to generate reconstructed frames 1121. Reconstructed frames 1121 may be provided to projection face boundary deblocker 104 for deblocking of pixel groups that are non-neighbors in reconstructed frames 1121 and are neighbors in the 360 video space of which reconstructed frames 1121 include projections. As shown, projection face boundary deblocker 104 may generate 2D video frames 115 (e.g., 360 video space deblock filtered reconstructed frames) based on reconstructed frames 1121, which may be stored in frame buffer 1105 and provided to motion compensation module 1102 for use in inter prediction. Furthermore, 2D video frames 115 may be provided for output to a display device or the like for viewing by a user.

By implementing decoder 1100 and, in particular, projection face boundary deblocker 104 within decoder 1100, improved video quality of video represented by 2D video frames 115 may be attained. For example, as discussed, projection face boundary deblocker 104 may receive an individual 2D reconstructed video frame of reconstructed video frames 1121 such that the individual 2D reconstructed video frame includes a projection from a 360 video space. Projection face boundary deblocker 104 determines groups of pixels from the individual 2D reconstructed video frame are non-neighboring in the individual 2D reconstructed video frame and that include pixels that are neighboring in the 360 video space. Such groups of pixels are deblock filtered to generate a filtered frame of 2D video frames 115 (e.g., a 360 video space deblock filtered reconstructed frame). Also as discussed, input bitstream 114 is decoded by entropy decoder module 1114 to determine quantized transform coefficients for a residual portion (e.g., a block or coding unit or the like) of the reconstructed 2D video frame. The quantized transform coefficients may be inverse quantized, by inverse quantization module 1112, and inverse transformed, by inverse transform module 1113, to generate a residual portion. The residual portion may be added to a corresponding prediction portion at by adder 1109 to generate a reconstructed portion. The reconstructed portion may then be in-frame deblock filtered by in-frame deblock filtering (DF) module 1106 and the prediction portion and other prediction portions may be assembled to generate a reconstructed frame of reconstructed frames 1121.

Projection face boundary deblocker 104 may receive the reconstructed frame of reconstructed frames 1121 such that the individual 2D reconstructed video frame includes a projection from a 360 video space. Projection face boundary deblocker 104 determines groups of pixels from the individual 2D reconstructed video frame are non-neighboring in the individual 2D reconstructed video frame and that include pixels that are neighboring in the 360 video space. Such groups of pixels are deblock filtered to generate a filtered frame of 2D video frames 115. With reference to FIG. 1, 2D video frames 115 may be displayed to a user by selecting a viewport for display (e.g., by user or application selection or the like), determining a portion of the filtered frame of 2D video frames 115 for display based on the viewport, and displaying the portion of the reconstructed 2D video frame to a user or users or the like.

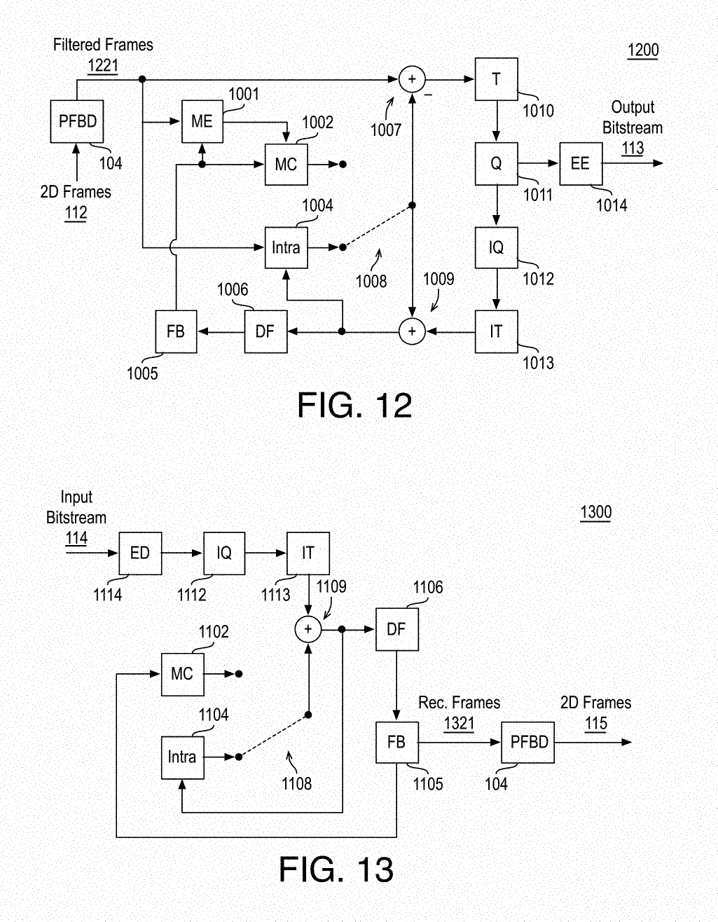

FIG. 12 illustrates a block diagram of an example encoder 1200, arranged in accordance with at least some implementations of the present disclosure. For example, encoder 1200 may provide out of loop or pre-processing projection face boundary deblocking based on the techniques discussed herein. As shown, encoder 1200 may include motion estimation (ME) module 1001, motion compensation (MC) module 1002, intra prediction (Intra) module 1004, frame buffer (FB) 1005, in-frame deblock filtering (DF) module 1006, differencer 1007, selection switch 1008, adder 1009, transform (T) module 1010, quantization (Q) module 1011, inverse quantization (IQ) module 1012, inverse transform (IT) module 1013, entropy encoder (EE) module 1014, and projection face boundary deblocker (PFBD) 104. Encoder 1200 may include additional modules and/or interconnections that are not shown for the sake of clarity of presentation.

As shown, encoder 1200 may receive 2D video frames 112 (e.g., 2D video frames that are projected from a 360 or spherical space) and encoder 1200 may generate output bitstream 113 as discussed herein. For example, encoder 1200 may include projection face boundary deblocker 104 as a pre-processor or pre-filter for improved encoder efficiency and video quality. In some examples, projection face boundary deblocker 104 may be characterized as a part of encoder 1200 and, in other examples, projection face boundary deblocker 104 may be characterized as a pre-processor or pre-filter prior to encode processing.

For example, projection face boundary deblocker 104 may receive 2D video frames 112 (e.g., 2D video frames that are projected from a 360 or spherical space) and projection face boundary deblocker 104 may generate 360 video space deblock filtered frames (filtered frames) 1221 as discussed herein. Filtered frames 1221 may then be encode processed as discussed with respect to FIG. 10 to generate output bitstream 113. Such encode processing will not be repeated for the sake of brevity.

By implementing encoder 1200 and, in particular, projection face boundary deblocker 104, improved encoding quality and compression and improved video quality of video represented by output bitstream 113 may be attained. For example, as discussed, projection face boundary deblocker 104 may receive an individual 2D video frame of 2D video frames 112 such that the individual 2D video frame includes a projection from a 360 video space. Projection face boundary deblocker 104 determines groups of pixels from the individual 2D video frame are non-neighboring in the individual 2D reconstructed video frame and that include pixels that are neighboring in the 360 video space. Such groups of pixels are deblock filtered to generate a filtered frame of 360 video space deblock filtered frames 1221. Also as discussed, a portion (e.g., a block or coding unit or the like) of the 360 video space deblock filtered frame may be differenced, by differencer 1007, with a corresponding portion of a reconstructed video frame (e.g., as reconstructed by the local decode loop and as selected by intra- or inter-prediction) to generate a residual portion. The residual portion may be transformed, by transform module 1010, and quantized, by quantization module 1011, to determine quantized transform coefficients for the residual portion. The quantized transform coefficients may be encoded into output bitstream 113 by entropy encoder module 1014.

FIG. 13 illustrates a block diagram of an example decoder 1300, arranged in accordance with at least some implementations of the present disclosure. For example, decoder 1300 may provide out of loop or post-processing projection face boundary deblocking based on the techniques discussed herein. As shown, decoder 1300 may include motion compensation (MC) module 1102, intra prediction (Intra) module 1104, frame buffer (FB) 1105, in-frame deblock filtering (DF) module 1106, selection switch 1108, adder 1109, inverse quantization (IQ) module 1112, inverse transform (IT) module 1113, entropy decoder (ED) module 1114, and projection face boundary deblocker (PFBD) 104. Decoder 1300 may include additional modules and/or interconnections that are not shown for the sake of clarity of presentation.

As shown, decoder 1300 may receive input bitstream 114 (e.g., an input bitstream corresponding to or representing 2D video frames that are projected from a 360 or spherical space) and decoder 1300 may generate 2D video frames 115 (e.g., such that 2D frames are projected from a 360 or spherical space). For example, decoder 1300 may include projection face boundary deblocker 104 as a post-processor or post-filter for improved video quality. In some examples, projection face boundary deblocker 104 may be characterized as a part of decoder 1300 and, in other examples, projection face boundary deblocker 104 may be characterized as a post-processor or post-filter prior to decode processing.

For example, decoder 1300 may receive input bitstream 114, which may be decode processed to generate reconstructed frames 1121 (e.g., reconstructed 2D video frames that are projected from a 360 or spherical space). Such decode processing will not be repeated for the sake of brevity. As shown, reconstructed frames 1121 may be stored in frame buffer 1105 and used for decode of subsequent video frames. Furthermore, projection face boundary deblocker 104 may receive a reconstructed frame of reconstructed frames 1321 such that the individual 2D reconstructed video frame includes a projection from a 360 video space. Projection face boundary deblocker 104 determines groups of pixels from the individual 2D reconstructed video frame are non-neighboring in the individual 2D reconstructed video frame and that include pixels that are neighboring in the 360 video space. Such groups of pixels are deblock filtered to generate a filtered frame of 2D video frames 115. With reference to FIG. 1, 2D video frames 115 may be displayed to a user by selecting a viewport for display (e.g., by user or application selection or the like), determining a portion of the filtered frame of 2D video frames 115 for display based on the viewport, and displaying the portion of the reconstructed 2D video frame to a user or users or the like.

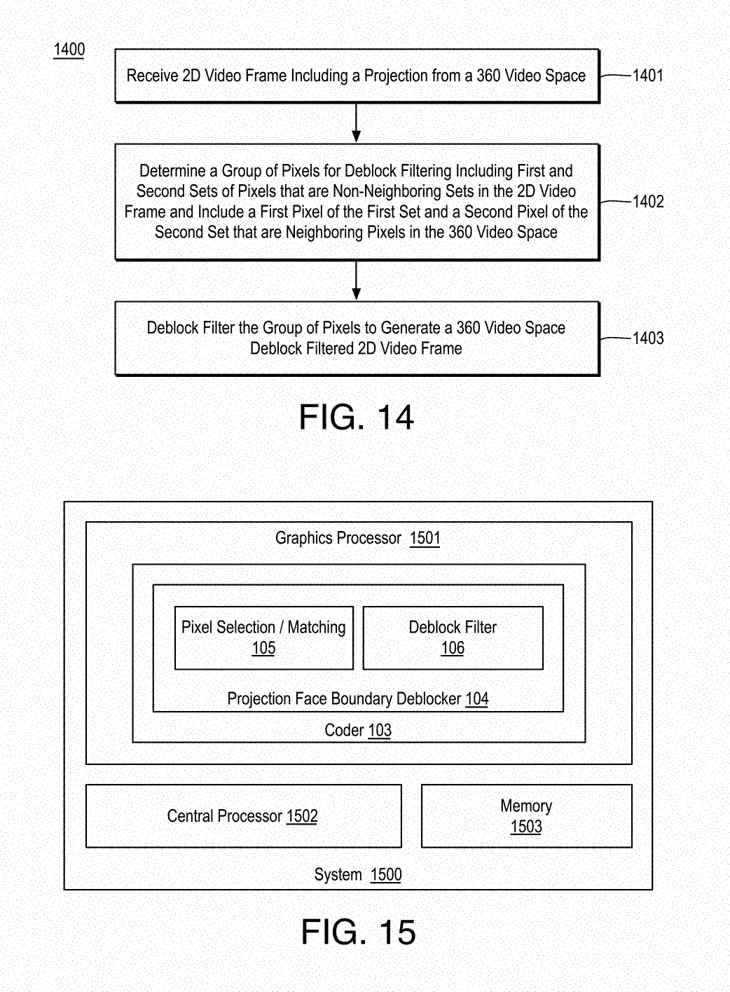

FIG. 14 is a flow diagram illustrating an example process 1400 for video coding video frames that include projections from a 360 video space, arranged in accordance with at least some implementations of the present disclosure. Process 1400 may include one or more operations 1401-1403 as illustrated in FIG. 14. Process 1400 may form at least part of a video coding process. By way of non-limiting example, process 1400 may form at least part of a video encoding process, video decoding process, video pre-processing, or video-post processing for video as undertaken by system 100 as discussed herein. Furthermore, process 1400 will be described herein in reference to system 1500 of FIG. 15.

FIG. 15 is an illustrative diagram of an example system 1500 for video coding video frames that include projections from a 360 video space, arranged in accordance with at least some implementations of the present disclosure. As shown in FIG. 15, system 1500 may include a graphics processor 1501, a central processor 1502, and a memory 1503. Also as shown, graphics processor 1501 may include coder 103, which may include projection face boundary deblocker 104, which may, as shown, include, pixel selection and matching module 105 and deblock filter 106. In the example of system 1500, memory 1503 may store video content such as video frames or a bitstream or any other data or parameters discussed herein.

Graphics processor 1501 may include any number and type of graphics processors or processing units that may provide the operations as discussed herein. Such operations may be implemented via software or hardware or a combination thereof. In an embodiment, the illustrated modules of graphics processor 1501 may be implemented via circuitry or the like. For example, graphics processor 1501 may include circuitry dedicated to manipulate video data to generate a compressed bitstream and/or circuitry dedicated to manipulate a compressed bitstream to generate video data and to provide the operations discussed herein. For example, graphics processor 1501 may include an electronic circuit to manipulate and alter memory to accelerate the creation of video frames in a frame buffer and/or to manipulate and alter memory to accelerate the creation of a bitstream based on images or frames of video.

Central processor 1502 may include any number and type of processing units or modules that may provide control and other high level functions for system 1500 and/or provide the operations discussed herein. For example, central processor 1502 may include an electronic circuit to perform the instructions of a computer program by performing basic arithmetic, logical, control, input/output operations, and the like specified by the instructions.

Memory 1503 may be any type of memory such as volatile memory (e.g., Static Random Access Memory (SRAM), Dynamic Random Access Memory (DRAM), etc.) or non-volatile memory (e.g., flash memory, etc.), and so forth. In an embodiment, memory 1503 may be configured to store video data such as pixel values, control parameters, bitstream data, or any other video data discussed herein. In a non-limiting example, memory 1503 may be implemented by cache memory. In an embodiment, coder 103 may be implemented via execution units (EU) of graphics processor 1501. The execution units may include, for example, programmable logic or circuitry such as a logic core or cores that may provide a wide array of programmable logic functions. In an embodiment, coder 103 may be implemented via dedicated hardware such as fixed function circuitry or the like. Fixed function circuitry may include dedicated logic or circuitry and may provide a set of fixed function entry points that may map to the dedicated logic for a fixed purpose or function.

Returning to discussion of FIG. 14, process 1400 may begin at operation 1401, where an individual 2-dimensional (2D) video frame from a video sequence of 2D video frames is received for processing such that the individual 2D video frame includes a projection from a 360 video space. The individual 2D video frame may include a projection from any suitable 360 video space in any suitable format. For example, the individual 2D video frame may include an equirectangular frame projected from the 360 video space, a cube map format frame projected from the 360 video space, a compact cube map format frame projected from the 360 video space or the like. For example, coder 103 as implemented via graphics processor 1501 may receive or generate the individual 2-dimensional video frame for processing.

Furthermore, the individual 2D video frame may be received for processing in any suitable context. For example, graphics processor 1501 and/or central processor 1502 may implement any encoder, decoder, pre-processor, post-processor, or the like discussed herein. In an embodiment, the individual 2D video frame is a reconstructed 2D video frame and process 1400 further includes differencing a portion of the face boundary deblock filtered 2D video frame with a portion of an original 2D video frame to generate a residual portion, transforming and quantizing the residual portion to determine quantized transform coefficients for the residual portion, encoding the quantized transform coefficients into a bitstream. For example, such processing may provide an in loop deblock filtering for encode.

In another embodiment, the individual 2D video frame is a filtered reconstructed 2D video frame and process 1400 further includes decoding a bitstream to determine quantized transform coefficients for a residual portion of the reconstructed 2D video frame, inverse quantizing and inverse transforming the quantized transform coefficients to determine the residual portion, adding the residual portion to a prediction portion to generate a reconstructed portion of a reconstructed 2D video frame, in-frame deblock filtering the reconstructed 2D video frame to generate the filtered reconstructed 2D video frame, determining a portion of the face boundary deblock filtered 2D video frame for display based on a viewport (e.g., a 100 degree field of view), and displaying the portion of the reconstructed 2D video frame to a user. For example, such processing may provide deblock filtering for decode and display to a user.

In an embodiment, process 1400 further includes differencing a portion of the face boundary deblock filtered 2D video frame with a portion of a reconstructed video frame to generate a residual portion, transforming and quantizing the residual portion to determine quantized transform coefficients for the residual portion, and encoding the quantized transform coefficients into a bitstream. For example, such processing may provide a pre-processing deblock filtering for encode.

Processing may continue at operation 1402, where, from the individual 2D video frame, a group of pixels for deblock filtering may be determined such that the group of pixels includes a first set of pixels and a second set of pixels of the individual 2D video frame such that the first set of pixels and the second set of pixels are non-neighboring sets of pixels in the individual 2D video frame and such that a first individual pixel of the first set of pixels and a second individual pixel of the second set of pixels are neighboring pixels in the 360 video space. For example, pixel selection and matching module 105 of coder 103 as implemented via graphics processor 1501 may determine the group of pixels for deblock filtering. The group of pixels for deblock filtering may be determined using any suitable technique or techniques such as any techniques discussed herein.

In an embodiment, the first set of pixels begins with the first individual pixel at a left boundary of the individual 2D video frame and extends toward an interior of the individual 2D video frame and the second set of pixels begins with the second individual pixel at a right boundary of the individual 2D video frame and extends toward the interior of the individual 2D video frame. In an embodiment, the individual 2D video frame is an equirectangular frame projected from the 360 video space and the first set of pixels begins with the first individual pixel at a first position of a top boundary of the individual 2D video frame and extends toward an interior of the individual 2D video frame, the second set of pixels begins with the second individual pixel at a second position of the top boundary of the individual 2D video frame and extends toward the interior of the individual 2D video frame, and the first position and the second position of the top boundary are equidistant from a center of the top boundary of the individual 2D video frame.

In an embodiment, the individual 2D video frame is a cube map format frame projected from the 360 video space and the first set of pixels begins with the first individual pixel at a first position of a first face projection and a first blank pixel region boundary of the individual 2D video frame and extends toward an interior of the first face projection, the second set of pixels begins with the second individual pixel at a second position of a second face projection and a second blank pixel region boundary and extends toward an interior of the second face projection, and the first position and the second position are equidistant from an intersection of the first and second blank pixel region boundaries. In an embodiment, the individual 2D video frame is a compact cube map format frame projected from the 360 video space and the first set of pixels begins with the first individual pixel at a first face projection and video frame edge boundary of the individual 2D video frame and extends toward an interior of the first face projection and the second set of pixels begins with the second individual pixel at a second face projection and a third face projection boundary and extends toward an interior of the second face projection.

Any number of groups of pixels may be identified for deblock filtering. In an embodiment, the group of pixels is a single line of pixels and process 1400 further includes determining, from the individual 2D video frame, a second group of pixels for deblock filtering such that the second group of pixels includes a third set of pixels and a fourth set of pixels of the individual 2D video frame, such that the third set of pixels and the fourth set of pixels are non-neighboring pixels in the individual 2D video frame and at least a third individual pixel of the third set of pixels and a fourth individual pixel of the fourth set of pixels are neighboring pixels in the 360 video space. For example, the individual 2D video frame may be an equirectangular frame projected from the 360 video space, the first set of pixels may begin with the first individual pixel at a left boundary of the individual 2D video frame and extend toward an interior of the individual 2D video frame, the second set of pixels may begin with the second individual pixel at a right boundary of the individual 2D video frame and extend toward the interior of the individual 2D video frame, the third set of pixels may begin with the third individual pixel at a first position of a top boundary of the individual 2D video frame and extend toward the interior of the individual 2D video frame, the fourth set of pixels may begin with the fourth individual pixel at a second position of the top boundary of the individual 2D video frame and extend toward the interior of the individual 2D video frame, and the first position and the second position of the top boundary may be equidistant from a center of the top boundary of the individual 2D video frame.

Processing may continue at operation 1403, where the group of pixels including the first and second set of pixels may be deblock filtered to generate a 360 video space deblock filtered 2D video frame based on the individual 2D video frame. The group of pixels or groups of pixels may be deblock filtered using any suitable technique or techniques. Each group may be deblock filtered using the same filtering techniques or different filtering techniques. In an embodiment, the group of pixels includes a single line of pixels and said deblock filtering the group of pixels includes applying a low pass filter to the group of pixels.

Various components of the systems described herein may be implemented in software, firmware, and/or hardware and/or any combination thereof. For example, various components of system 100 or system 1500 may be provided, at least in part, by hardware of a computing System-on-a-Chip (SoC) such as may be found in a computing system such as, for example, a smart phone. Those skilled in the art may recognize that systems described herein may include additional components that have not been depicted in the corresponding figures. For example, the systems discussed herein may include additional components such as bit stream multiplexer or de-multiplexer modules and the like that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement the techniques, modules, components, or the like as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

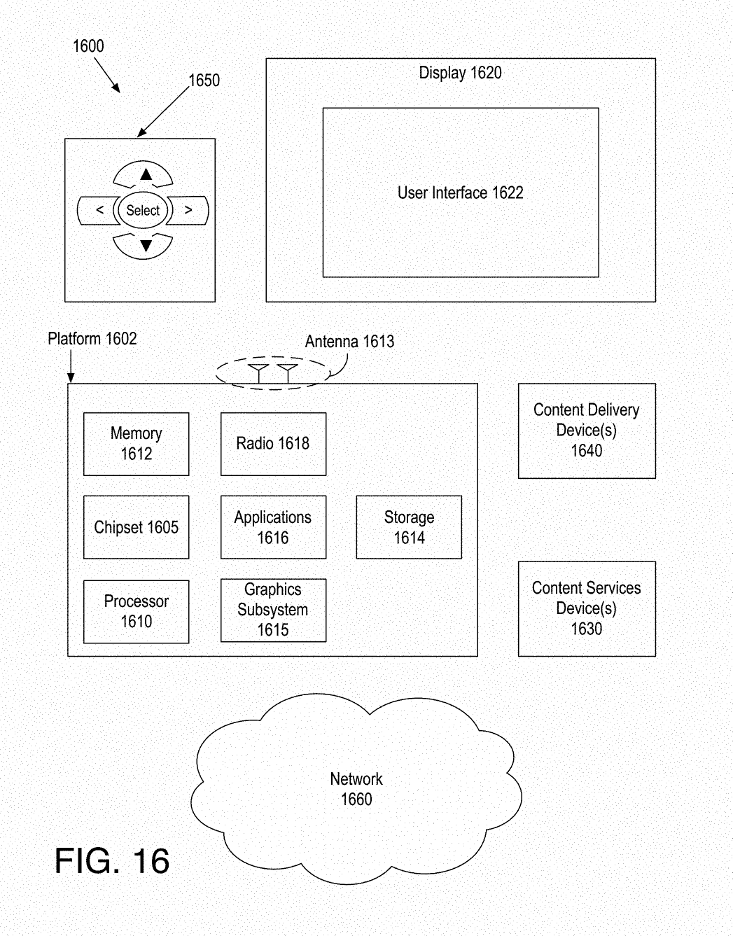

FIG. 16 is an illustrative diagram of an example system 1600, arranged in accordance with at least some implementations of the present disclosure. In various implementations, system 1600 may be a mobile system although system 1600 is not limited to this context. For example, system 1600 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 1600 includes a platform 1602 coupled to a display 1620. Platform 1602 may receive content from a content device such as content services device(s) 1630 or content delivery device(s) 1640 or other similar content sources. A navigation controller 1650 including one or more navigation features may be used to interact with, for example, platform 1602 and/or display 1620. Each of these components is described in greater detail below.

In various implementations, platform 1602 may include any combination of a chipset 1605, processor 1610, memory 1612, antenna 1613, storage 1614, graphics subsystem 1615, applications 1616 and/or radio 1618. Chipset 1605 may provide intercommunication among processor 1610, memory 1612, storage 1614, graphics subsystem 1615, applications 1616 and/or radio 1618. For example, chipset 1605 may include a storage adapter (not depicted) capable of providing intercommunication with storage 1614.

Processor 1610 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1610 may be dual-core processor(s), dual-core mobile processor(s), and so forth.

Memory 1612 may be implemented as a volatile memory device such as, but not limited to, a Random Access Memory (RAM), Dynamic Random Access Memory (DRAM), or Static RAM (SRAM).

Storage 1614 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1614 may include technology to increase the storage performance enhanced protection for valuable digital media when multiple hard drives are included, for example.

Graphics subsystem 1615 may perform processing of images such as still or video for display. Graphics subsystem 1615 may be a graphics processing unit (GPU) or a visual processing unit (VPU), for example. An analog or digital interface may be used to communicatively couple graphics subsystem 1615 and display 1620. For example, the interface may be any of a High-Definition Multimedia Interface, DisplayPort, wireless HDMI, and/or wireless HD compliant techniques. Graphics subsystem 1615 may be integrated into processor 1610 or chipset 1605. In some implementations, graphics subsystem 1615 may be a stand-alone device communicatively coupled to chipset 1605.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 1618 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1618 may operate in accordance with one or more applicable standards in any version.

In various implementations, display 1620 may include any television type monitor or display. Display 1620 may include, for example, a computer display screen, touch screen display, video monitor, television-like device, and/or a television. Display 1620 may be digital and/or analog. In various implementations, display 1620 may be a holographic display. Also, display 1620 may be a transparent surface that may receive a visual projection. Such projections may convey various forms of information, images, and/or objects. For example, such projections may be a visual overlay for a mobile augmented reality (MAR) application. Under the control of one or more software applications 1616, platform 1602 may display user interface 1622 on display 1620.

In various implementations, content services device(s) 1630 may be hosted by any national, international and/or independent service and thus accessible to platform 1602 via the Internet, for example. Content services device(s) 1630 may be coupled to platform 1602 and/or to display 1620. Platform 1602 and/or content services device(s) 1630 may be coupled to a network 1660 to communicate (e.g., send and/or receive) media information to and from network 1660. Content delivery device(s) 1640 also may be coupled to platform 1602 and/or to display 1620.

In various implementations, content services device(s) 1630 may include a cable television box, personal computer, network, telephone, Internet enabled devices or appliance capable of delivering digital information and/or content, and any other similar device capable of uni-directionally or bi-directionally communicating content between content providers and platform 1602 and/display 1620, via network 1660 or directly. It will be appreciated that the content may be communicated uni-directionally and/or bi-directionally to and from any one of the components in system 1600 and a content provider via network 1660. Examples of content may include any media information including, for example, video, music, medical and gaming information, and so forth.

Content services device(s) 1630 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1602 may receive control signals from navigation controller 1650 having one or more navigation features. The navigation features of may be used to interact with user interface 1622, for example. In various embodiments, navigation may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of may be replicated on a display (e.g., display 1620) by movements of a pointer, cursor, focus ring, or other visual indicators displayed on the display. For example, under the control of software applications 1616, the navigation features located on navigation may be mapped to virtual navigation features displayed on user interface 1622, for example. In various embodiments, may not be a separate component but may be integrated into platform 1602 and/or display 1620. The present disclosure, however, is not limited to the elements or in the context shown or described herein.

In various implementations, drivers (not shown) may include technology to enable users to instantly turn on and off platform 1602 like a television with the touch of a button after initial boot-up, when enabled, for example. Program logic may allow platform 1602 to stream content to media adaptors or other content services device(s) 1630 or content delivery device(s) 1640 even when the platform is turned “off.” In addition, chipset 1605 may include hardware and/or software support for 5.1 surround sound audio and/or high definition 7.1 surround sound audio, for example. Drivers may include a graphics driver for integrated graphics platforms. In various embodiments, the graphics driver may include a peripheral component interconnect (PCI) Express graphics card.

In various implementations, any one or more of the components shown in system 1600 may be integrated. For example, platform 1602 and content services device(s) 1630 may be integrated, or platform 1602 and content delivery device(s) 1640 may be integrated, or platform 1602, content services device(s) 1630, and content delivery device(s) 1640 may be integrated, for example. In various embodiments, platform 1602 and display 1620 may be an integrated unit. Display 1620 and content service device(s) 1630 may be integrated, or display 1620 and content delivery device(s) 1640 may be integrated, for example. These examples are not meant to limit the present disclosure.

In various embodiments, system 1600 may be implemented as a wireless system, a wired system, or a combination of both. When implemented as a wireless system, system 1600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1602 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 16.

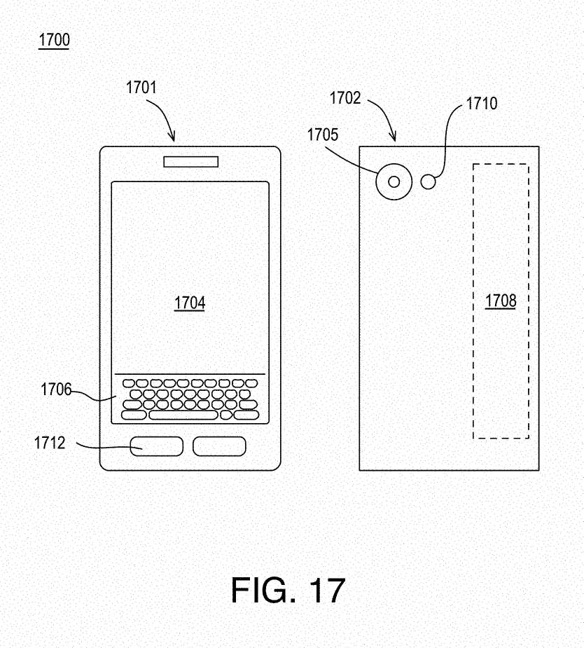

As described above, system 1600 may be embodied in varying physical styles or form factors. FIG. 17 illustrates an example small form factor device 1700, arranged in accordance with at least some implementations of the present disclosure. In some examples, system 1600 may be implemented via device 1700. In other examples, system 1500 or portions thereof may be implemented via device 1700. In various embodiments, for example, device 1700 may be implemented as a mobile computing device a having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smart phone, smart tablet or smart mobile television), mobile internet device (MID), messaging device, data communication device, cameras, and so forth.

Examples of a mobile computing device also may include computers that are arranged to be worn by a person, such as a wrist computers, finger computers, ring computers, eyeglass computers, belt-clip computers, arm-band computers, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 17, device 1700 may include a housing with a front 1701 and a back 1702. Device 1700 includes a display 1704, an input/output (I/O) device 1706, and an integrated antenna 1708. Device 1700 also may include navigation features 1712. I/O device 1706 may include any suitable I/O device for entering information into a mobile computing device. Examples for I/O device 1706 may include an alphanumeric keyboard, a numeric keypad, a touch pad, input keys, buttons, switches, microphones, speakers, voice recognition device and software, and so forth. Information also may be entered into device 1700 by way of microphone (not shown), or may be digitized by a voice recognition device. As shown, device 1700 may include a camera 1705 (e.g., including a lens, an aperture, and an imaging sensor) and a flash 1710 integrated into back 1702 (or elsewhere) of device 1700. In other examples, camera 1705 and flash 1710 may be integrated into front 1701 of device 1700 or both front and back cameras may be provided. Camera 1705 and flash 1710 may be components of a camera module to originate image data processed into streaming video that is output to display 1704 and/or communicated remotely from device 1700 via antenna 1708 for example.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

In one or more first embodiments, a computer-implemented method for video coding comprises receiving an individual 2-dimensional (2D) video frame from a video sequence of 2D video frames, such that the individual 2D video frame comprises a projection from a 360 video space, determining, from the individual 2D video frame, a group of pixels for deblock filtering, such that the group of pixels comprises a first set of pixels and a second set of pixels of the individual 2D video frame, the first set of pixels and the second set of pixels are non-neighboring sets of pixels in the individual 2D video frame and at least a first individual pixel of the first set of pixels and a second individual pixel of the second set of pixels comprise neighboring pixels in the 360 video space, and deblock filtering the group of pixels comprising the first and second set of pixels to generate a 360 video space deblock filtered 2D video frame based on the individual 2D video frame.

Further to the first embodiments, the individual 2D video frame comprises one of an equirectangular frame projected from the 360 video space, a cube map format frame projected from the 360 video space, or a compact cube map format frame projected from the 360 video space.

Further to the first embodiments, the first set of pixels begins with the first individual pixel at a left boundary of the individual 2D video frame and extends toward an interior of the individual 2D video frame and the second set of pixels begins with the second individual pixel at a right boundary of the individual 2D video frame and extends toward the interior of the individual 2D video frame.

Further to the first embodiments, the individual 2D video frame comprises an equirectangular frame projected from the 360 video space, the first set of pixels begins with the first individual pixel at a first position of a top boundary of the individual 2D video frame and extends toward an interior of the individual 2D video frame, the second set of pixels begins with the second individual pixel at a second position of the top boundary of the individual 2D video frame and extends toward the interior of the individual 2D video frame, and the first position and the second position of the top boundary are equidistant from a center of the top boundary of the individual 2D video frame.

Further to the first embodiments, the individual 2D video frame comprises a cube map format frame projected from the 360 video space, the first set of pixels begins with the first individual pixel at a first position of a first face projection and a first blank pixel region boundary of the individual 2D video frame and extends toward an interior of the first face projection, the second set of pixels begins with the second individual pixel at a second position of a second face projection and a second blank pixel region boundary and extends toward an interior of the second face projection, and the first position and the second position are equidistant from an intersection of the first and second blank pixel region boundaries.

Further to the first embodiments, the individual 2D video frame comprises a compact cube map format frame projected from the 360 video space, the first set of pixels begins with the first individual pixel at a first face projection and video frame edge boundary of the individual 2D video frame and extends toward an interior of the first face projection and the second set of pixels begins with the second individual pixel at a second face projection and a third face projection boundary and extends toward an interior of the second face projection.

Further to the first embodiments, the group of pixels comprises a single line of pixels and said deblock filtering the group of pixels comprises applying a low pass filter to the group of pixels.

Further to the first embodiments, the group of pixels comprises a single line of pixels and the method further comprises determining, from the individual 2D video frame, a second group of pixels for deblock filtering, such that the second group of pixels comprises a third set of pixels and a fourth set of pixels of the individual 2D video frame, the third set of pixels and the fourth set of pixels are non-neighboring pixels in the individual 2D video frame and at least a third individual pixel of the third set of pixels and a fourth individual pixel of the fourth set of pixels comprise neighboring pixels in the 360 video space, such that the individual 2D video frame comprises an equirectangular frame projected from the 360 video space, the first set of pixels begins with the first individual pixel at a left boundary of the individual 2D video frame and extends toward an interior of the individual 2D video frame, the second set of pixels begins with the second individual pixel at a right boundary of the individual 2D video frame and extends toward the interior of the individual 2D video frame, the third set of pixels begins with the third individual pixel at a first position of a top boundary of the individual 2D video frame and extends toward the interior of the individual 2D video frame, the fourth set of pixels begins with the fourth individual pixel at a second position of the top boundary of the individual 2D video frame and extends toward the interior of the individual 2D video frame, and the first position and the second position of the top boundary are equidistant from a center of the top boundary of the individual 2D video frame.

Further to the first embodiments, the individual 2D video frame comprises a reconstructed 2D video frame and the method further comprises differencing a portion of the 360 video space deblock filtered 2D video frame with a portion of an original 2D video frame to generate a residual portion, such that the 360 video space deblock filtered 2D video frame is a reference frame with respect to the original 2D video frame, transforming and quantizing the residual portion to determine quantized transform coefficients for the residual portion, and encoding the quantized transform coefficients into a bitstream.

Further to the first embodiments, the individual 2D video frame comprises a filtered reconstructed 2D video frame and the method further comprises decoding a bitstream to determine quantized transform coefficients for a residual portion of a reconstructed 2D video frame, inverse quantizing and inverse transforming the quantized transform coefficients to determine the residual portion, adding the residual portion to a prediction portion to generate a reconstructed portion of the reconstructed 2D video frame, in-frame deblock filtering the reconstructed 2D video frame to generate the filtered reconstructed 2D video frame, determining a portion of the 360 video space deblock filtered 2D video frame for display based on a viewport, and displaying the portion of the reconstructed 2D video frame to a user.

Further to the first embodiments, the method further comprises differencing a portion of the 360 video space deblock filtered 2D video frame with a portion of a reconstructed video frame to generate a residual portion, transforming and quantizing the residual portion to determine quantized transform coefficients for the residual portion, and encoding the quantized transform coefficients into a bitstream.

In one or more second embodiments, a system for video coding comprises a memory to store an individual 2-dimensional (2D) video frame from a video sequence of 2D video frames, such that the individual 2D video frame comprises a projection from a 360 video space and a processor coupled to the memory, the processor to receive the individual 2-dimensional (2D) video frame, to determine, from the individual 2D video frame, a group of pixels for deblock filtering, such that the group of pixels comprises a first set of pixels and a second set of pixels of the individual 2D video frame, the first set of pixels and the second set of pixels are non-neighboring sets of pixels in the individual 2D video frame and at least a first individual pixel of the first set of pixels and a second individual pixel of the second set of pixels comprise neighboring pixels in the 360 video space, and to deblock filter the group of pixels comprising the first and second set of pixels to generate a 360 video space deblock filtered 2D video frame based on the individual 2D video frame.

Further to the second embodiments, the individual 2D video frame comprises one of an equirectangular frame projected from the 360 video space, a cube map format frame projected from the 360 video space, or a compact cube map format frame projected from the 360 video space.

Further to the second embodiments, the first set of pixels begins with the first individual pixel at a left boundary of the individual 2D video frame and extends toward an interior of the individual 2D video frame and the second set of pixels begins with the second individual pixel at a right boundary of the individual 2D video frame and extends toward the interior of the individual 2D video frame.

Further to the second embodiments, the individual 2D video frame comprises an equirectangular frame projected from the 360 video space, the first set of pixels begins with the first individual pixel at a first position of a top boundary of the individual 2D video frame and extends toward an interior of the individual 2D video frame, the second set of pixels begins with the second individual pixel at a second position of the top boundary of the individual 2D video frame and extends toward the interior of the individual 2D video frame, and the first position and the second position of the top boundary are equidistant from a center of the top boundary of the individual 2D video frame.

Further to the second embodiments, the individual 2D video frame comprises a cube map format frame projected from the 360 video space, the first set of pixels begins with the first individual pixel at a first position of a first face projection and a first blank pixel region boundary of the individual 2D video frame and extends toward an interior of the first face projection, the second set of pixels begins with the second individual pixel at a second position of a second face projection and a second blank pixel region boundary and extends toward an interior of the second face projection, and the first position and the second position are equidistant from an intersection of the first and second blank pixel region boundaries.

Further to the second embodiments, the individual 2D video frame comprises a compact cube map format frame projected from the 360 video space, the first set of pixels begins with the first individual pixel at a first face projection and video frame edge boundary of the individual 2D video frame and extends toward an interior of the first face projection and the second set of pixels begins with the second individual pixel at a second face projection and a third face projection boundary and extends toward an interior of the second face projection.

Further to the second embodiments, the group of pixels comprises a single line of pixels and the processor to deblock filter the group of pixels comprises the processor to apply a low pass filter to the group of pixels.

Further to the second embodiments, the group of pixels comprises a single line of pixels and the processor is further to determine, from the individual 2D video frame, a second group of pixels for deblock filtering, such that the second group of pixels comprises a third set of pixels and a fourth set of pixels of the individual 2D video frame, the third set of pixels and the fourth set of pixels are non-neighboring pixels in the individual 2D video frame and at least a third individual pixel of the third set of pixels and a fourth individual pixel of the fourth set of pixels comprise neighboring pixels in the 360 video space, such that the individual 2D video frame comprises an equirectangular frame projected from the 360 video space, the first set of pixels begins with the first individual pixel at a left boundary of the individual 2D video frame and extends toward an interior of the individual 2D video frame, the second set of pixels begins with the second individual pixel at a right boundary of the individual 2D video frame and extends toward the interior of the individual 2D video frame, the third set of pixels begins with the third individual pixel at a first position of a top boundary of the individual 2D video frame and extends toward the interior of the individual 2D video frame, the fourth set of pixels begins with the fourth individual pixel at a second position of the top boundary of the individual 2D video frame and extends toward the interior of the individual 2D video frame, and the first position and the second position of the top boundary are equidistant from a center of the top boundary of the individual 2D video frame.

Further to the second embodiments, the individual 2D video frame comprises a reconstructed 2D video frame and the processor is further to difference portion of the 360 video space deblock filtered 2D video frame with a portion of an original 2D video frame to generate a residual portion, such that the 360 video space deblock filtered 2D video frame is a reference frame with respect to the original 2D video frame, to transform and quantize the residual portion to determine quantized transform coefficients for the residual portion, and to encode the quantized transform coefficients into a bitstream.

Further to the second embodiments, the individual 2D video frame comprises a filtered reconstructed 2D video frame and the processor is further to decode a bitstream to determine quantized transform coefficients for a residual portion of a reconstructed 2D video frame, to inverse quantize and inverse transform the quantized transform coefficients to determine the residual portion, to add the residual portion to a prediction portion to generate a reconstructed portion of the reconstructed 2D video frame, to in-frame deblock filter the reconstructed 2D video frame to generate the filtered reconstructed 2D video frame, to determine a portion of the 360 video space deblock filtered 2D video frame for display based on a viewport, and to display the portion of the reconstructed 2D video frame to a user.

Further to the second embodiments, the processor is further to difference a portion of the 360 video space deblock filtered 2D video frame with a portion of a reconstructed video frame to generate a residual portion, to transform and quantize the residual portion to determine quantized transform coefficients for the residual portion, and to encode the quantized transform coefficients into a bitstream.

In one or more third embodiments, a system comprises means for receiving an individual 2-dimensional (2D) video frame from a video sequence of 2D video frames, such that the individual 2D video frame comprises a projection from a 360 video space, means for determining, from the individual 2D video frame, a group of pixels for deblock filtering, such that the group of pixels comprises a first set of pixels and a second set of pixels of the individual 2D video frame, the first set of pixels and the second set of pixels are non-neighboring sets of pixels in the individual 2D video frame and at least a first individual pixel of the first set of pixels and a second individual pixel of the second set of pixels comprise neighboring pixels in the 360 video space, and means for deblock filtering the group of pixels comprising the first and second set of pixels to generate a 360 video space deblock filtered 2D video frame based on the individual 2D video frame.

Further to the third embodiments, the first set of pixels begins with the first individual pixel at a left boundary of the individual 2D video frame and extends toward an interior of the individual 2D video frame and the second set of pixels begins with the second individual pixel at a right boundary of the individual 2D video frame and extends toward the interior of the individual 2D video frame.

Further to the third embodiments, the individual 2D video frame comprises an equirectangular frame projected from the 360 video space, the first set of pixels begins with the first individual pixel at a first position of a top boundary of the individual 2D video frame and extends toward an interior of the individual 2D video frame, the second set of pixels begins with the second individual pixel at a second position of the top boundary of the individual 2D video frame and extends toward the interior of the individual 2D video frame, and the first position and the second position of the top boundary are equidistant from a center of the top boundary of the individual 2D video frame.

Further to the third embodiments, the individual 2D video frame comprises a cube map format frame projected from the 360 video space, the first set of pixels begins with the first individual pixel at a first position of a first face projection and a first blank pixel region boundary of the individual 2D video frame and extends toward an interior of the first face projection, the second set of pixels begins with the second individual pixel at a second position of a second face projection and a second blank pixel region boundary and extends toward an interior of the second face projection, and the first position and the second position are equidistant from an intersection of the first and second blank pixel region boundaries.

Further to the third embodiments, the individual 2D video frame comprises a compact cube map format frame projected from the 360 video space, the first set of pixels begins with the first individual pixel at a first face projection and video frame edge boundary of the individual 2D video frame and extends toward an interior of the first face projection and the second set of pixels begins with the second individual pixel at a second face projection and a third face projection boundary and extends toward an interior of the second face projection.

Further to the third embodiments, the individual 2D video frame comprises a reconstructed 2D video frame and the system further comprises differencing a portion of the 360 video space deblock filtered 2D video frame with a portion of an original 2D video frame to generate a residual portion, such that the 360 video space deblock filtered 2D video frame is a reference frame with respect to the original 2D video frame, means for transforming and quantizing the residual portion to determine quantized transform coefficients for the residual portion, and means for encoding the quantized transform coefficients into a bitstream.

Further to the third embodiments, the individual 2D video frame comprises a filtered reconstructed 2D video frame and the system further comprises means for decoding a bitstream to determine quantized transform coefficients for a residual portion of a reconstructed 2D video frame, means for inverse quantizing and inverse transforming the quantized transform coefficients to determine the residual portion, means for adding the residual portion to a prediction portion to generate a reconstructed portion of the reconstructed 2D video frame, means for in-frame deblock filtering the reconstructed 2D video frame to generate the filtered reconstructed 2D video frame, means for determining a portion of the 360 video space deblock filtered 2D video frame for display based on a viewport, and means for displaying the portion of the reconstructed 2D video frame to a user.

In one or more fourth embodiments, at least one machine readable medium comprises a plurality of instructions that, in response to being executed on a computing device, cause the computing device to perform video coding by receiving an individual 2-dimensional (2D) video frame from a video sequence of 2D video frames, such that the individual 2D video frame comprises a projection from a 360 video space, determining, from the individual 2D video frame, a group of pixels for deblock filtering, such that the group of pixels comprises a first set of pixels and a second set of pixels of the individual 2D video frame, the first set of pixels and the second set of pixels are non-neighboring sets of pixels in the individual 2D video frame and at least a first individual pixel of the first set of pixels and a second individual pixel of the second set of pixels comprise neighboring pixels in the 360 video space, and deblock filtering the group of pixels comprising the first and second set of pixels to generate a 360 video space deblock filtered 2D video frame based on the individual 2D video frame.

Further to the fourth embodiments, the first set of pixels begins with the first individual pixel at a left boundary of the individual 2D video frame and extends toward an interior of the individual 2D video frame and the second set of pixels begins with the second individual pixel at a right boundary of the individual 2D video frame and extends toward the interior of the individual 2D video frame.

Further to the fourth embodiments, the individual 2D video frame comprises an equirectangular frame projected from the 360 video space, the first set of pixels begins with the first individual pixel at a first position of a top boundary of the individual 2D video frame and extends toward an interior of the individual 2D video frame, the second set of pixels begins with the second individual pixel at a second position of the top boundary of the individual 2D video frame and extends toward the interior of the individual 2D video frame, and the first position and the second position of the top boundary are equidistant from a center of the top boundary of the individual 2D video frame.

Further to the fourth embodiments, the individual 2D video frame comprises a cube map format frame projected from the 360 video space, the first set of pixels begins with the first individual pixel at a first position of a first face projection and a first blank pixel region boundary of the individual 2D video frame and extends toward an interior of the first face projection, the second set of pixels begins with the second individual pixel at a second position of a second face projection and a second blank pixel region boundary and extends toward an interior of the second face projection, and the first position and the second position are equidistant from an intersection of the first and second blank pixel region boundaries.

Further to the fourth embodiments, the individual 2D video frame comprises a compact cube map format frame projected from the 360 video space, the first set of pixels begins with the first individual pixel at a first face projection and video frame edge boundary of the individual 2D video frame and extends toward an interior of the first face projection and the second set of pixels begins with the second individual pixel at a second face projection and a third face projection boundary and extends toward an interior of the second face projection.

Further to the fourth embodiments, the individual 2D video frame comprises a reconstructed 2D video frame and the machine readable medium further comprises a plurality of instructions that, in response to being executed on the computing device, cause the computing device to perform video coding by differencing a portion of the 360 video space deblock filtered 2D video frame with a portion of an original 2D video frame to generate a residual portion, such that the 360 video space deblock filtered 2D video frame is a reference frame with respect to the original 2D video frame, transforming and quantizing the residual portion to determine quantized transform coefficients for the residual portion, and encoding the quantized transform coefficients into a bitstream.

Further to the fourth embodiments, the individual 2D video frame comprises a filtered reconstructed 2D video frame and the machine readable medium further comprises a plurality of instructions that, in response to being executed on the computing device, cause the computing device to perform video coding by decoding a bitstream to determine quantized transform coefficients for a residual portion of a reconstructed 2D video frame, inverse quantizing and inverse transforming the quantized transform coefficients to determine the residual portion, adding the residual portion to a prediction portion to generate a reconstructed portion of the reconstructed 2D video frame, in-frame deblock filtering the reconstructed 2D video frame to generate the filtered reconstructed 2D video frame, determining a portion of the 360 video space deblock filtered 2D video frame for display based on a viewport, and displaying the portion of the reconstructed 2D video frame to a user.

In one or more fifth embodiments, at least one machine readable medium may include a plurality of instructions that in response to being executed on a computing device, causes the computing device to perform a method according to any one of the above embodiments.

In one or more sixth embodiments, an apparatus or system may include means for performing a method according to any one of the above embodiments.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. A computer-implemented method for video coding comprising:
receiving an individual 2-dimensional (2D) video frame from a video sequence of 2D video frames, wherein the individual 2D video frame comprises a projection from a 360 video space;
determining, from the individual 2D video frame, a group of pixels for deblock filtering, wherein the group of pixels comprises a first set of pixels and a second set of pixels of the individual 2D video frame, wherein the first set of pixels and the second set of pixels are non-neighboring sets of pixels in the individual 2D video frame and wherein at least a first individual pixel of the first set of pixels and a second individual pixel of the second set of pixels comprise neighboring pixels in the 360 video space; and
deblock filtering the group of pixels comprising the first and second set of pixels to generate a 360 video space deblock filtered 2D video frame based on the individual 2D video frame.

2. The method of claim 1, wherein the individual 2D video frame comprises one of an equirectangular frame projected from the 360 video space, a cube map format frame projected from the 360 video space, or a compact cube map format frame projected from the 360 video space.

3. The method of claim 1, wherein the first set of pixels begins with the first individual pixel at a left boundary of the individual 2D video frame and extends toward an interior of the individual 2D video frame and the second set of pixels begins with the second individual pixel at a right boundary of the individual 2D video frame and extends toward the interior of the individual 2D video frame.

4. The method of claim 1, wherein the individual 2D video frame comprises an equirectangular frame projected from the 360 video space, and wherein the first set of pixels begins with the first individual pixel at a first position of a top boundary of the individual 2D video frame and extends toward an interior of the individual 2D video frame, the second set of pixels begins with the second individual pixel at a second position of the top boundary of the individual 2D video frame and extends toward the interior of the individual 2D video frame, and the first position and the second position of the top boundary are equidistant from a center of the top boundary of the individual 2D video frame.

5. The method of claim 1, wherein the individual 2D video frame comprises a cube map format frame projected from the 360 video space, and wherein the first set of pixels begins with the first individual pixel at a first position of a first face projection and a first blank pixel region boundary of the individual 2D video frame and extends toward an interior of the first face projection, the second set of pixels begins with the second individual pixel at a second position of a second face projection and a second blank pixel region boundary and extends toward an interior of the second face projection, and the first position and the second position are equidistant from an intersection of the first and second blank pixel region boundaries.

6. The method of claim 1, wherein the individual 2D video frame comprises a compact cube map format frame projected from the 360 video space, and wherein the first set of pixels begins with the first individual pixel at a first face projection and video frame edge boundary of the individual 2D video frame and extends toward an interior of the first face projection and the second set of pixels begins with the second individual pixel at a second face projection and a third face projection boundary and extends toward an interior of the second face projection.

7. The method of claim 1, wherein the group of pixels comprises a single line of pixels and said deblock filtering the group of pixels comprises applying a low pass filter to the group of pixels.

8. The method of claim 1, wherein the group of pixels comprises a single line of pixels and the method further comprises:
determining, from the individual 2D video frame, a second group of pixels for deblock filtering, wherein the second group of pixels comprises a third set of pixels and a fourth set of pixels of the individual 2D video frame, wherein the third set of pixels and the fourth set of pixels are non-neighboring pixels in the individual 2D video frame and wherein at least a third individual pixel of the third set of pixels and a fourth individual pixel of the fourth set of pixels comprise neighboring pixels in the 360 video space, wherein the individual 2D video frame comprises an equirectangular frame projected from the 360 video space, the first set of pixels begins with the first individual pixel at a left boundary of the individual 2D video frame and extends toward an interior of the individual 2D video frame, the second set of pixels begins with the second individual pixel at a right boundary of the individual 2D video frame and extends toward the interior of the individual 2D video frame, the third set of pixels begins with the third individual pixel at a first position of a top boundary of the individual 2D video frame and extends toward the interior of the individual 2D video frame, the fourth set of pixels begins with the fourth individual pixel at a second position of the top boundary of the individual 2D video frame and extends toward the interior of the individual 2D video frame, and the first position and the second position of the top boundary are equidistant from a center of the top boundary of the individual 2D video frame.

9. The method of claim 1, wherein the individual 2D video frame comprises a reconstructed 2D video frame and the method further comprises:
differencing a portion of the 360 video space deblock filtered 2D video frame with a portion of an original 2D video frame to generate a residual portion, wherein the 360 video space deblock filtered 2D video frame is a reference frame with respect to the original 2D video frame;
transforming and quantizing the residual portion to determine quantized transform coefficients for the residual portion; and
encoding the quantized transform coefficients into a bitstream.

10. The method of claim 1, wherein the individual 2D video frame comprises a filtered reconstructed 2D video frame and the method further comprises:
decoding a bitstream to determine quantized transform coefficients for a residual portion of a reconstructed 2D video frame;
inverse quantizing and inverse transforming the quantized transform coefficients to determine the residual portion;
adding the residual portion to a prediction portion to generate a reconstructed portion of the reconstructed 2D video frame;
in-frame deblock filtering the reconstructed 2D video frame to generate the filtered reconstructed 2D video frame;
determining a portion of the 360 video space deblock filtered 2D video frame for display based on a viewport; and
displaying the portion of the reconstructed 2D video frame to a user.

11. The method of claim 1 further comprising:
differencing a portion of the 360 video space deblock filtered 2D video frame with a portion of a reconstructed video frame to generate a residual portion;
transforming and quantizing the residual portion to determine quantized transform coefficients for the residual portion; and
encoding the quantized transform coefficients into a bitstream.

12. A system for video coding comprising:
a memory to store an individual 2-dimensional (2D) video frame from a video sequence of 2D video frames, wherein the individual 2D video frame comprises a projection from a 360 video space; and
a processor coupled to the memory, the processor to receive the individual 2-dimensional (2D) video frame, to determine, from the individual 2D video frame, a group of pixels for deblock filtering, wherein the group of pixels comprises a first set of pixels and a second set of pixels of the individual 2D video frame, wherein the first set of pixels and the second set of pixels are non-neighboring sets of pixels in the individual 2D video frame and wherein at least a first individual pixel of the first set of pixels and a second individual pixel of the second set of pixels comprise neighboring pixels in the 360 video space, and to deblock filter the group of pixels comprising the first and second set of pixels to generate a 360 video space deblock filtered 2D video frame based on the individual 2D video frame.

13. The system of claim 12, wherein the first set of pixels begins with the first individual pixel at a left boundary of the individual 2D video frame and extends toward an interior of the individual 2D video frame and the second set of pixels begins with the second individual pixel at a right boundary of the individual 2D video frame and extends toward the interior of the individual 2D video frame.

14. The system of claim 12, wherein the individual 2D video frame comprises an equirectangular frame projected from the 360 video space, and wherein the first set of pixels begins with the first individual pixel at a first position of a top boundary of the individual 2D video frame and extends toward an interior of the individual 2D video frame, the second set of pixels begins with the second individual pixel at a second position of the top boundary of the individual 2D video frame and extends toward the interior of the individual 2D video frame, and the first position and the second position of the top boundary are equidistant from a center of the top boundary of the individual 2D video frame.

15. The system of claim 12, wherein the individual 2D video frame comprises a cube map format frame projected from the 360 video space, and wherein the first set of pixels begins with the first individual pixel at a first position of a first face projection and a first blank pixel region boundary of the individual 2D video frame and extends toward an interior of the first face projection, the second set of pixels begins with the second individual pixel at a second position of a second face projection and a second blank pixel region boundary and extends toward an interior of the second face projection, and the first position and the second position are equidistant from an intersection of the first and second blank pixel region boundaries.

16. The system of claim 12, wherein the individual 2D video frame comprises a compact cube map format frame projected from the 360 video space, and wherein the first set of pixels begins with the first individual pixel at a first face projection and video frame edge boundary of the individual 2D video frame and extends toward an interior of the first face projection and the second set of pixels begins with the second individual pixel at a second face projection and a third face projection boundary and extends toward an interior of the second face projection.

17. The system of claim 12, wherein the individual 2D video frame comprises a reconstructed 2D video frame and the processor is further to difference portion of the 360 video space deblock filtered 2D video frame with a portion of an original 2D video frame to generate a residual portion, wherein the 360 video space deblock filtered 2D video frame is a reference frame with respect to the original 2D video frame, to transform and quantize the residual portion to determine quantized transform coefficients for the residual portion, and to encode the quantized transform coefficients into a bitstream.

18. The system of claim 12, wherein the individual 2D video frame comprises a filtered reconstructed 2D video frame and the processor is further to decode a bitstream to determine quantized transform coefficients for a residual portion of a reconstructed 2D video frame, to inverse quantize and inverse transform the quantized transform coefficients to determine the residual portion, to add the residual portion to a prediction portion to generate a reconstructed portion of the reconstructed 2D video frame, to in-frame deblock filter the reconstructed 2D video frame to generate the filtered reconstructed 2D video frame, to determine a portion of the 360 video space deblock filtered 2D video frame for display based on a viewport, and to display the portion of the reconstructed 2D video frame to a user.

19. At least one machine readable medium comprising a plurality of instructions that, in response to being executed on a computing device, cause the computing device to perform video coding by:
receiving an individual 2-dimensional (2D) video frame from a video sequence of 2D video frames, wherein the individual 2D video frame comprises a projection from a 360 video space;
determining, from the individual 2D video frame, a group of pixels for deblock filtering, wherein the group of pixels comprises a first set of pixels and a second set of pixels of the individual 2D video frame, wherein the first set of pixels and the second set of pixels are non-neighboring sets of pixels in the individual 2D video frame and wherein at least a first individual pixel of the first set of pixels and a second individual pixel of the second set of pixels comprise neighboring pixels in the 360 video space; and
deblock filtering the group of pixels comprising the first and second set of pixels to generate a 360 video space deblock filtered 2D video frame based on the individual 2D video frame.

20. The machine readable medium of claim 19, wherein the first set of pixels begins with the first individual pixel at a left boundary of the individual 2D video frame and extends toward an interior of the individual 2D video frame and the second set of pixels begins with the second individual pixel at a right boundary of the individual 2D video frame and extends toward the interior of the individual 2D video frame.

21. The machine readable medium of claim 19, wherein the individual 2D video frame comprises an equirectangular frame projected from the 360 video space, and wherein the first set of pixels begins with the first individual pixel at a first position of a top boundary of the individual 2D video frame and extends toward an interior of the individual 2D video frame, the second set of pixels begins with the second individual pixel at a second position of the top boundary of the individual 2D video frame and extends toward the interior of the individual 2D video frame, and the first position and the second position of the top boundary are equidistant from a center of the top boundary of the individual 2D video frame.

22. The machine readable medium of claim 19, wherein the individual 2D video frame comprises a cube map format frame projected from the 360 video space, and wherein the first set of pixels begins with the first individual pixel at a first position of a first face projection and a first blank pixel region boundary of the individual 2D video frame and extends toward an interior of the first face projection, the second set of pixels begins with the second individual pixel at a second position of a second face projection and a second blank pixel region boundary and extends toward an interior of the second face projection, and the first position and the second position are equidistant from an intersection of the first and second blank pixel region boundaries.

23. The machine readable medium of claim 19, wherein the individual 2D video frame comprises a compact cube map format frame projected from the 360 video space, and wherein the first set of pixels begins with the first individual pixel at a first face projection and video frame edge boundary of the individual 2D video frame and extends toward an interior of the first face projection and the second set of pixels begins with the second individual pixel at a second face projection and a third face projection boundary and extends toward an interior of the second face projection.

24. The machine readable medium of claim 19, wherein the individual 2D video frame comprises a reconstructed 2D video frame and the machine readable medium further comprises a plurality of instructions that, in response to being executed on the computing device, cause the computing device to perform video coding by:
differencing a portion of the 360 video space deblock filtered 2D video frame with a portion of an original 2D video frame to generate a residual portion, wherein the 360 video space deblock filtered 2D video frame is a reference frame with respect to the original 2D video frame;
transforming and quantizing the residual portion to determine quantized transform coefficients for the residual portion; and
encoding the quantized transform coefficients into a bitstream.

25. The machine readable medium of claim 19, wherein the individual 2D video frame comprises a filtered reconstructed 2D video frame and the machine readable medium further comprises a plurality of instructions that, in response to being executed on the computing device, cause the computing device to perform video coding by:
decoding a bitstream to determine quantized transform coefficients for a residual portion of a reconstructed 2D video frame;
inverse quantizing and inverse transforming the quantized transform coefficients to determine the residual portion;
adding the residual portion to a prediction portion to generate a reconstructed portion of the reconstructed 2D video frame;
in-frame deblock filtering the reconstructed 2D video frame to generate the filtered reconstructed 2D video frame;
determining a portion of the 360 video space deblock filtered 2D video frame for display based on a viewport; and
displaying the portion of the reconstructed 2D video frame to a user.
